(19) United States
(12) Patent Application Publication
(10) Pub. No.: US 2015/0224739 A1
(43) Pub. Date: Aug. 13, 2015

(54) HIGH PERFORMANCE NANOFIBERS AND MATS

(71) Applicant: CORNELL UNIVERSITY, Ithaca, NY (US)

(72) Inventors: Yong Lak Joo, Ithaca, NY (US); Nathaniel S. Hansen, Portland, OR (US)

(73) Assignee: CORNELL UNIVERSITY, Ithaca, NY (US)

(21) Appl. No.: 14/428,399

(22) PCT Filed: Sep. 16, 2013
(86) PCT No.: PCT/US13/59879

§ 371 Date: Mar. 16, 2015

Related U.S. Application Data
(60) Provisional application No. 61/701,871, filed on Sep. 17, 2012.

(51) Int. Cl. B32B 5/12; B29C 47/06; B29C 71/00; B29C 47/00

(52) U.S. Cl. CPC B32B 5/12; B29C 47/0004; B29C 47/0014; B29C 47/065; B29C 71/00; B32B 2262/103; B32B 2262/105; B29L 2009/00

(57) ABSTRACT

Provided herein are nanofibers, nanofiber mats, and processes for preparing the same. In particular, provided herein are improved nanofibers and nanofiber mats, as well as processes for preparing nanofibers and nanofiber mats, having high performance characteristics. In some instances, such processes involve depositing nanofibers in a distinctly layered structure, which allows nanofibers to retain structural integrity upon post-electrospinning processing, which in turn provides resultant nanofibers with high performance characteristics.

### CROSS-REFERENCE

This application claims the benefit of U.S. Provisional Application No. 61/701,871, filed Sep. 17, 2012, which is incorporated herein by reference in its entirety.

### BACKGROUND OF THE INVENTION

Methods for attempts to produce ceramic or metallic nanofibers result in materials having many disadvantages, such as low performance, poor coherence, and limited options for the types of materials that can be produced. Such disadvantages make any materials produced by such methods unsuitable for many applications.

### SUMMARY OF THE INVENTION

Provided herein are high performance nanofibers (e.g., nanofibers comprising high metal content, such as metals, metal oxides, ceramics, metal carbides, or the like) and nanofiber mats (e.g., non-woven mats). Also provided herein are processes for providing nanofibers having high or improved performance. In specific embodiments, the nanofibers or at least a plurality of nanofibers of a nanofiber mat comprise at least one metal component (e.g., metal, metal oxide, metal carbide, ceramic, or combinations thereof). In specific embodiments, the metal component comprises at least one metal in an oxidation state of zero or greater (e.g., 0-4). In certain embodiments, the nanofibers comprise (a) metal nanofibers; (b) metal oxide nanofibers; (c) metal carbide nanofibers; (d) ceramic nanofibers; or (e) a combination thereof. In some embodiments, the metal component comprises at least two metals (e.g., a metal-metal alloy). In certain embodiments, the at least one metal component comprises at least two metal components (e.g., a nanocomposite nanostructure).

In some embodiments, nanofiber mats provided herein comprise nanofiber(s) (e.g., precursor nanofiber(s)) comprising at least two nanofiber layers (oriented in different directions). In specific instances, the precursor nanofibers comprise (a) a polymer component—e.g., a continuous matrix of polymer; and (b) metal component (e.g., metal, metal oxide, ceramic, metal carbide, or the like) nanoparticles or metal precursor.

In certain embodiments, nanofiber mats provided herein comprise nanofiber(s) (e.g., nanofiber(s) prepared by treating precursor nanofibers described herein) comprising at least two nanofiber layers (oriented in different directions). In specific embodiments, the nanofibers comprise a matrix (e.g., continuous matrix) of metal component—e.g., metal, metal oxide, ceramic, metal carbide, or the like. In other specific embodiments, the nanofibers comprise a carbon matrix (e.g., continuous matrix) with the metal component embedded therein.

Provided in certain embodiments herein is a process for preparing a multilayered nanofiber material, the process comprising:
a. depositing a first nanofiber layer on a collector, the first nanofiber layer comprising a plurality of first nanofiber segments (e.g., one or more first nanofiber comprising the plurality of first nanofiber segments); and
b. depositing a second nanofiber layer adjacent (on top of) the first nanofiber layer, the second nanofiber layer comprising a plurality of second nanofiber segments (e.g., one or more second nanofiber comprising the plurality of second nanofiber segments).

Provided in certain embodiments herein is a process for preparing a multilayered nanofiber material, the process comprising:
a. electrospinning a first nanofiber layer on a collector, the first nanofiber layer comprising a plurality of first nanofiber segments; and
b. electrospinning a second nanofiber layer adjacent (on top of) the first nanofiber layer, the second nanofiber layer comprising a plurality of second nanofiber segments.

In specific the first nanofiber layer and the second nanofiber comprise nanofiber(s) that are the same or different. In some instances, the layers may be different—such as comprising different materials—i.e., chemically distinguishable—different materials may include different polymer and/or different precursor and/or nanoparticles, which may in turn result in chemically distinguishable third and fourth nanofibers—e.g., different metals, ceramics, etc. In other instances, the layers may be structurally distinguishable—such as having different average nanofiber diameters, or the like (e.g., from using different gas flow rates, nozzle diameters, precursor loading parameters, or the like). Generally, deposition (e.g., electrospinning) of the nanofiber layers produces a multilayered nanofiber material. In more specific embodiments, the multilayered nanofiber material has a distinctly layered structure—e.g., the first layer is distinct from the second layer, such as by orientation of the nanofiber layers. In some embodiments, distinct layers are layers that are distinguishable from one another as separate layers. Generally, distinct layers are not layers of randomly oriented nanofibers layered on one another. In still more specific embodiments, the distinctly layered nanofiber material has a first nanofiber layer with a first direction (e.g., as determined by an average direction of the nanofiber segments in the first nanofiber layer) and a second nanofiber layer with a second direction (e.g., as determined by an average direction of the nanofiber segments in the second nanofiber layer), wherein the first and second directions are not parallel.

Provided in specific embodiments herein is a process for preparing a multilayered nanofiber material, the process comprising:
a. electrospinning a first nanofiber layer on a collector, the first nanofiber layer comprising a plurality of first nanofiber segments and being oriented in a first direction; and
b. electrospinning a second nanofiber layer adjacent (on top of) the first nanofiber layer, the second nanofiber layer comprising a plurality of second nanofiber segments and being oriented in a second direction, the first and second directions being non-parallel (e.g., being oriented at an angle of 60-90 degrees to one another).

In certain embodiments, the nanofibers of either or both of the first and/or second nanofiber layer(s) comprise (i) polymer; and (ii) metal precursor or nanoparticles. In specific embodiments, the nanofibers of both of the first and second nanofiber layer(s) comprise (i) polymer; and (ii) metal precursor or nanoparticles. In more specific embodiments, the nanofibers of both of the first and second nanofiber layer(s) comprise (i) polymer; and (ii) metal precursor (which may be partially or completely complexed with the polymer). In certain embodiments, the first nanofiber layer, the second nanofiber layer, or both are deposited by electrospinning a fluid stock comprises or is prepared by combining (i) polymer (e.g., a water soluble polymer, such as PVA, PEO, or the like); and (ii) metal precursor and/or metal nanoparticles. In specific embodiments, the fluid stock comprises or is prepared by combining (i) polymer; (ii) metal precursor and/or metal nanoparticles; and (iii) water. In more specific embodiments, the fluid stock is prepared by combining (i) polymer; (ii) metal precursor; and (iii) water.

In specific embodiments, depositing of the first and second nanofiber layers described herein is achieved by electrospinning. In some embodiments, the first and/or second nanofibers are electrospun with a gas stream. For example, in specific embodiments, the electrospinning of either or both of the first and second nanofibers is gas-assisted electrospinning. In more specific embodiments, the gas-assisted electrospinning is coaxial (common-axial) gas assisted electrospinning (e.g., a fluid stock and gas are conconcentrically expressed—e.g., within 5 degrees and within 25 nm—about a common axis). In some instances, gas-assisted electrospinning provides for higher fluid throughput and a higher rate of nanofiber production. In certain instances, when nanoparticles are utilized, gas-assisted electrospinning maintains nanoparticle dispersion in the fluid stock (e.g., a high fluid throughput reduces nanoparticle aggregation) in the electrospinning nozzle, which produces nanofibers having a polymer matrix with non-aggregated and/or well dispersed nanoparticles embedded therein.

In certain embodiments, the plurality of first nanofiber segments of the first nanofiber layer are aligned. In other words, nanofiber segments within the layer are aligned with one another. Such alignment includes alignment of portions of the first nanofibers (e.g., a first nanofiber may have several segments that are aligned by arranging the nanofiber to be oriented to go back and forth in an “S” pattern—such as illustrated in FIG. 10). Such alignment also includes alignment of individual first nanofibers (also illustrated in FIG. 10). In some embodiments, the plurality of second nanofiber segments are aligned. In specific embodiments, the first nanofiber segments are aligned and the second nanofiber segments are aligned.

In certain embodiments, alignment of the nanofibers includes alignment of the nanofiber segments in a parallel manner. In some embodiments, the nanofibers are aligned in a substantially parallel manner. In specific embodiments, substantially parallel aligned nanofiber layers comprise at least 50% of the nanofiber segments thereof being aligned within 30 degrees (e.g., within 15 degrees) of the overall layer (e.g., as determined by taking the mean or median orientation of the plurality of nanofibers of the layer).

In some embodiments, the first nanofiber layer is oriented in a first direction; the second nanofiber layer is oriented in a second direction; and the first and second directions are oriented in a non-parallel manner. Generally, the first direction and second direction must be within 0 degrees (parallel) to 90 degrees (orthogonal) to one another. In specific instances, the layers are within 1-90 degrees of one another. In more specific embodiments, the layers are oriented within 30-90 degrees to one another. In still more specific embodiments, the layers are oriented within 45-90 degrees of one another. In yet more specific embodiments, the layers are oriented within 60-90 degrees, or about 90 degrees of one another.

Any suitable process is optionally utilized to align the nanofibers and nanofiber layers. In some embodiments, the nanofiber segments are aligned by: moving an electrospinner in relation to the collector; moving the collector in relation to an electrospinner; manipulating an electrical field between an electrospinner and the collector; utilizing a gas stream to control the movement and deposition of the electrospun nanofiber; flowing a fluid past the deposited nanofibers; aligning the nanofibers with a magnetic field; or any combination thereof. In various embodiments, the collector is optionally a split collector or a rotating drum.

In specific embodiments, the nanofibers of the first and/or second nanofiber layers have an average diameter of at most 1000 nm. In more specific embodiments, both the first and second nanofiber layers have an average diameter of at most 1000 nm. In still more specific embodiments, the first and second nanofiber layers comprise nanofibers that are the same (comprising the same materials) and have a diameter of at most 1000 nm. In some specific embodiments, the average diameter is at most 900 nm.

In some embodiments, any process described herein comprises treating (e.g., thermally and/or chemically treating) the multilayered nanofiber material. In specific embodiments, one or more first nanofiber(s) comprising the plurality of first nanofiber segments and the first nanofiber(s) are converted into third nanofiber(s) (e.g., metal precursor is calcined and/or polymer matrix is carbonized or removed). In specific embodiments, the third nanofiber(s) have an average density, average volume and/or average diameter that is less than (e.g., at least 25% less than) that of the first nanofiber(s). In further or alternative embodiments, one or more second nanofiber(s) comprising the plurality of second nanofiber segments and the second nanofiber(s) are converted into fourth nanofiber(s) (e.g., metal precursor is calcined—e.g., to elemental metal, metal oxide, metal carbide, etc.—and/or polymer matrix is carbonized or removed). In specific embodiments, the fourth nanofiber(s) have an average density, average volume and/or average diameter that is less than (e.g., at least 25% less than) that of the second nanofiber(s).

In some embodiments, the treatment (e.g., thermal and/or chemical treatment) comprises calcination that comprises (e.g., thermal) calcination of metal precursors present in the nanofiber material. For example, in certain embodiments, calcination of the plurality of first nanofiber segments produces a plurality of third nanofiber segments. In further or alternative embodiments, calcination of the plurality of second nanofiber segments produces a plurality of fourth nanofiber segments. In certain embodiments, the treatment (e.g., thermal and/or chemical treatment) comprises degradation (e.g., degradation of polymer to carbon and gaseous/sublimed material) and/or removal (e.g., degradation of polymer to carbon dioxide and other gaseous/sublimed material) of polymer present in the nanofiber material. For example, in some embodiments, treatment of the plurality of first nanofiber segments produces a plurality of third nanofiber segments wherein polymer is removed (e.g., the third nanofiber segment comprising a continuous metal, metal oxide, or metal carbide matrix) or degraded (e.g., the third nanofiber segments comprising a continuous carbon matrix). In further or alternative embodiments, treatment of the plurality of second nanofiber segments produces a plurality of fourth nanofiber segments wherein polymer is removed (e.g., the fourth nanofiber segments comprising a continuous metal, metal oxide, or metal carbide matrix) or degraded (e.g., the fourth nanofiber segments comprising a continuous carbon matrix). In specific embodiments, treatment of the first and second nanofibers (comprising metal precursor) results in calcination of metal precursors in both the first and second nanofibers and removal of polymer (e.g., degradation of the polymer to produce carbon dioxide and other gaseous/sublimed materials). In other specific embodiments, treatment of the first and second nanofibers (comprising nanoparticles) results in the polymer of both the first and second nanofibers being carbonized, and the resulting nanofibers comprising nanoparticles (e.g., non-aggregated and/or uniformly dispersed nanoparticles) embedded therein.

Provided in specific embodiments herein is a process for preparing a multilayered nanofiber material, the process comprising:
a. electrospinning a first nanofiber layer on a collector, the first nanofiber layer comprising one or more first nanofibers and being oriented in a first direction, the one or more first nanofibers (i) comprising a plurality of first nanofiber segments, and (ii) comprising polymer and metal precursor (which precursor may be partially or completely complexed with the polymer); and
b. electrospinning a second nanofiber layer adjacent (on top of) the first nanofiber layer, the second nanofiber layer comprising a plurality of second nanofibers and being oriented in a second direction, the one or more second nanofibers (i) comprising a plurality of second nanofiber segments, and (ii) comprising polymer and metal precursor, the first and second directions being non-parallel;
c. thermally treating the first and second nanofiber layers to produce third and fourth nanofiber layers, the third nanofiber layer comprising one or more third nanofiber(s), the third nanofiber(s) comprising a continuous metal, metal oxide, ceramic, or metal carbide matrix, the fourth nanofiber layer comprising one or more fourth nanofiber(s), the fourth nanofiber(s) comprising a continuous metal, metal oxide, ceramic, or metal carbide matrix.

Provided in other specific embodiments herein is a process for preparing a multilayered nanofiber material, the process comprising:
a. electrospinning a first nanofiber layer on a collector, the first nanofiber layer comprising one or more first nanofibers and being oriented in a first direction, the one or more first nanofibers (i) comprising a plurality of first nanofiber segments, and (ii) comprising polymer and a plurality of nanoparticles; and
b. electrospinning a second nanofiber layer adjacent (on top of) the first nanofiber layer, the second nanofiber layer comprising a plurality of second nanofibers and being oriented in a second direction, the one or more second nanofibers (i) comprising a plurality of second nanofiber segments, and (ii) comprising polymer and a plurality of nanoparticles, the first and second directions being non-parallel;
c. thermally treating the first and second nanofiber layers to produce third and fourth nanofiber layers, the third nanofiber layer comprising one or more third nanofiber(s), the third nanofiber(s) comprising a continuous carbon matrix with nanoparticles embedded therein, the fourth nanofiber layer comprising one or more fourth nanofiber(s), the fourth nanofiber(s) comprising a continuous carbon matrix with nanoparticles embedded therein.

In specific the first nanofiber layer and the second nanofiber layer comprise nanofiber(s) that are the same or different; and the third and fourth nanofiber layers comprise nanofiber(s) that are the same or different. In more specific embodiments, the first and second nanofiber layers comprise nanofiber(s) that are the same, and the third and fourth nanofiber layers comprise nanofiber(s) that are the same. In some embodiments, the multilayered nanofiber material is a distinctly layered nanofiber material—e.g., the first layer is distinct from the second layer, such as by orientation of the nanofiber layers.

Depositing of any one or more of the nanofiber layers described herein is optionally achieved by electrospining the nanofibers of the layer. In other embodiments, interfacial polymerization of the nanofibers of the layer, electro-blowing of the nanofibers of the layer, or a combination thereof may alternatively be utilized. In specific embodiments, first and second nanofiber layers are deposited by electrospinning.

In some embodiments, processes described herein (e.g., following thermal treatment, polymer degradation and/or removal, and/or calcination of metal precursor) provide nanofibers (e.g., third and/or fourth nanofibers) described herein that have reduced wrinkling or curling (e.g., compared to similarly prepared nanofibers prepared by deposition of isotropic (randomly oriented) nanofibers—e.g., in mats, layers, or the like). In specific embodiments, such wrinkling or curling is reduced by at least 25%, reduced by at least 50%, or is eliminated.

In some embodiments, the processes described herein (e.g., following thermal treatment, polymer degradation and/or removal, and/or calcination of metal precursor) provide nanofibers (e.g., third and/or fourth nanofibers) described herein that have a reduced diameter relative to pre-treated nanofibers. For example, in some embodiments, the average diameter of the third and fourth nanofibers, if present, is less than the average diameter of the first and second nanofibers, respectively. In some instances, this occurs as a result of the ordered mats holding the first and second nanofibers in position—maintaining the length of the nanofibers. In such instances, the loss of volume due to mass loss (e.g., from polymer and/or ligand degradation and/or removal) occurs substantially at the expense of the nanofiber diameter. In specific instances, the diameter of the third and/or fourth nanofibers is reduced at least 10% or at least 25% relative to the diameter of the first and/or second nanofibers, respectively. Further, in some embodiments, the length of the third and/or fourth nanofibers are substantially the same (e.g., 75% or greater, or 90% or greater) of the first and/or second nanofibers, respectively.

In some embodiments, the processes described herein (e.g., following thermal treatment, polymer degradation and/or removal, and/or calcination of metal precursor) provide nanofibers (e.g., third and/or fourth nanofibers) described herein that have an average length of at least 750 microns. In more specific embodiments, the nanofibers (e.g., third and/or fourth nanofibers described herein) have an average length of at least 1 mm. In still more specific embodiments, the nanofibers (e.g., third and/or fourth nanofibers described herein) have an average length of at least 1.5 mm, or at least 2 mm. In some embodiments, the nanofibers (e.g., third and/or fourth nanofibers described herein) comprise a continuous metal, metal oxide, metal carbide, or ceramic matrix and have an average length of at least 1 mm (e.g., at least 1.5 mm, at least 2 mm, or at least 5 mm). In certain embodiments, the nanofibers (e.g., third and/or fourth nanofibers described herein) have an average aspect ratio of at least 1,000. In specific embodiments, the nanofibers have an average aspect ratio of at least 10,000. In still more specific embodiments, the nanofibers have an average aspect ratio of at least 25,000 (e.g., at least 50,000, at least 100,000, or the like). In some embodiments, the nanofibers comprise a continuous metal, metal oxide, metal carbide, or ceramic matrix and have an average aspect ratio of at least 10,000 (e.g., at least 25,000 or at least 100,000). In some embodiments, the nanofibers comprise a continuous metal, metal oxide, metal carbide, or ceramic matrix and have an average aspect ratio of at least 10,000 (e.g., at least 25,000 or at least 100,000) and an average length of at least 1 mm (e.g., at least 1.5 mm, at least 2 mm, or at least 5 mm).

In certain embodiments, first and/or second nanofibers comprise a polymer. In more specific embodiments, the first and/or second nanofibers comprise (i) a polymer and (ii) a metal precursor (e.g., some or all of the precursor being associated with the polymer) and/or a plurality of nanoparticles (e.g., ceramic, metal oxide or elemental metal nanoparticles). In certain embodiments, the polymer is water-soluble or water-swellable (e.g., prepared from a fluid stock comprising water—which, when combined with the polymer provides an electrospinnable stock).

In certain embodiments, the polymer in a pre-treated nanofiber (e.g., the first and/or second nanofibers) herein or a fluid stock herein is polyvinyl alcohol (PVA), polyvinyl acetate (PVAc), polyacrylonitrile (PAN), polyvinyl ether, polyvinyl pyrrolidone, polyglycolic acid, polyethylene oxide (PEO), hydroxyethylcellulose (HEC), cellulose, ethylcellulose, cellulose ethers, polyacrylic acid, polyisocyanate, or any combination thereof. In some embodiments, metal precursor in a pre-treated nanofiber herein or in or used in making a fluid stock herein is a metal-ligand complex. In specific embodiments, the precursor is a metal acetate, metal nitrate, metal chloride, metal alko-oxide, metal acetylacetonate, or any combination thereof (after the fluid stock is prepared, some or all of the precursor may associate with the polymer).

In some embodiments, a post-treated nanofiber herein (e.g., the third and/or fourth nanofibers) comprise a metal, a metal alloy, a metal carbide, a metal sulfide, a ceramic, or any combination thereof. In specific embodiments, such nanofibers comprise a continuous matrix of a metal, a metal alloy, a metal carbide, a metal sulfide, a ceramic, or any combination thereof. In some embodiments, the metal of the metal, a metal alloy, a metal carbide, a metal sulfide, a ceramic, or any combination thereof comprises one or more of the following metals: Fe, Ti, Si, Ag, Cu, Ni, Co, Au, Al, Zr, Li, Na, Mg, Ca, Hf, Mn, Ru, Rh, Zn, Cd, Sn, Ge, Pb, Cr, or any combination thereof.

Also, provided herein are any nanofibers, nanofiber mats, or layered nanofiber materials described as being prepared according to any process herein, including pre- and post-treatment nanofiber materials.

In some embodiments, provided herein is a multilayered nanofiber mat, the multilayered nanofiber mat comprising at least two layers (e.g., distinct layers—such as distinguished by different orientations). In some embodiments, the mat comprises at least a first nanofiber layer and a second nanofiber layer; the second nanofiber layer being adjacent (e.g., on top of) the first nanofiber layer. In some embodiments, the first nanofiber layer comprises one or more first nanofibers comprising a plurality of nanofiber segments, the plurality of first nanofiber segments being aligned (e.g., in a first direction) (e.g., parallel to one another). In further or alternative embodiments, the second nanofiber layer comprises one or more second nanofiber(s) comprising a plurality of second nanofiber segments, the plurality of second nanofiber segments being aligned (e.g., in a second direction) (e.g., parallel to one another). In some embodiments, the first and second nanofibers are the same or different. In some embodiments, the orientation of the first nanofiber layer (e.g., the mean or median orientation of the plurality of first nanofiber segments) is non-parallel with the orientation of the second nanofiber layer (e.g., the mean or median orientation of the plurality of second nanofiber segments).

In certain embodiments, the nanofibers are as described herein. In specific embodiments, the nanofibers comprise polymer and metal precursor (which may be partially or completely associated with the polymer). In other specific embodiments, the nanofibers comprise polymer and a plurality of nanoparticles embedded therein (e.g., wherein the nanoparticles are well dispersed and non-aggregated). In more specific embodiments, the nanofibers comprise polymer, metal precursor, and a plurality of nanoparticles. (In some instances, such nanofibers generally correspond to descriptions of pre-treated nanofibers described herein.) In some embodiments, nanofibers comprise a continuous matrix of a metal component, such as elemental metal, metal alloy, ceramic, metal carbide, metal oxide, combinations thereof, or the like. In certain embodiments, nanofibers comprise a continuous matrix of a carbon with metal component, such as elemental metal, metal alloy, ceramic, metal carbide, metal oxide, combinations thereof, or the like, embedded therein (e.g., as nanoparticles). (In certain instances, such nanofibers generally correspond to descriptions of post-treated nanofibers described herein.) In some embodiments, the metal of the precursor, nanoparticles, or the metal component of the continuous matrix comprises Fe, Ti, Si, Ag, Cu, Ni, Co, Au, Al, Zr, Li, Na, Mg, Ca, Hf, Mn, Ru, Rh, Zn, Cd, Sn, Ge, or any combination thereof. In some embodiments, nanofibers described herein that have an average length of at least 750 microns. In more specific embodiments, the nanofibers have an average length of at least 1 mm. In still more specific embodiments, the nanofibers have an average length of at least 1.5 mm, or at least 2 mm. In some embodiments, the nanofibers comprise a continuous metal, metal oxide, metal carbide, or ceramic matrix and have an average length of at least 1 mm. In certain embodiments, the nanofibers have an average aspect ratio of at least 1,000. In specific embodiments, the nanofibers have an average aspect ratio of at least 10,000. In still more specific embodiments, the nanofibers have an average aspect ratio of at least 25,000 (e.g., at least 50,000, at least 100,000, or the like). In some embodiments, the nanofibers comprise a continuous metal, metal oxide, metal carbide, or ceramic matrix and have an average aspect ratio of at least 10,000 (e.g., at least 25,000 or at least 100,000). In some embodiments, the nanofibers comprise a continuous metal, metal oxide, metal carbide, or ceramic matrix and have an average aspect ratio of at least 10,000 (e.g., at least 25,000 or at least 100,000) and an average length of at least 1 mm (e.g., at least 1.5 mm, at least 2 mm, or at least 5 mm).

In some embodiments, provided herein is a multilayered nanofiber mat comprising at least two layers, each layer comprising a plurality of nanofiber segments, at least 50% (or 25% or 75%) of the nanofiber segments of each layer being oriented within 15 degrees (or 30 degrees) of the orientation of the nanofiber layer within which the plurality of nanofiber segments reside. In more specific embodiments, each layer is oriented at an angle of 1-90 degrees (e.g., about 90 degrees) of an adjacent layer(s). In certain embodiments, the layers are oriented at an angle of 30-90 degrees (e.g., 60-90 degrees) to an adjacent layer(s). In some embodiments, multilayered nanofiber mats provided herein comprise at least five layers. In more specific embodiments, multilayered nanofiber mats provided herein comprise at least ten layers.

The nanofiber mat of any one of the preceding claims, having a less than 50% decrease in electrical conductivity over 5 cm (or 4 cm, or 3 cm) of mat (e.g., compared to the electrical conductivity over 1 cm of a same or similar—such as comprising identical materials and orientations—mat).

In some embodiments, such mats are multi-layered nanofiber mats (e.g., having distinct layers—e.g., such layers having distinct orientations from each other). In specific embodiments, the nanofibers of the mats comprise the same materials (e.g., the same metal, metal oxide, or the like). In some embodiments, provided herein are metal or metal oxide nanofiber mats having an electrical conductivity of at least 4,000 S/m (e.g., at least 5,000 S/m, at least 10,000 S/m, or more—such as over at least 3 cm, over 4 cm, or over 5 cm).

Also, provided in certain embodiments, are devices or materials comprising the nanofiber materials described herein. In some embodiments, such a device/material includes a catalyst, a membrane, an optical device, an electrode (e.g., anode and cathode) or a superconductor.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 illustrates a schematic of an apparatus and process for preparing nanofibers and nanofiber mats described herein.

FIG. 2 illustrates a coaxial electrospinning apparatus useful for producing nanofibers described herein.

FIG. 3 illustrates a schematic of the deposited nanofiber mats and the treatment of such nanofiber mats to produce treated nanofiber mats (e.g., comprising metal a metal component, such as metal, metal oxide, metal alloy, ceramic, metal carbide, combinations thereof, or the like).

FIG. 4 illustrates a nanocomposite nanofiber comprising a continuous matrix and discrete domains (e.g., of a metal component).

FIG. 5 illustrates surface topology analysis of isotropic nanofiber mats. FIG. 5A illustrates AFM images of isotropic nanofibers before and after treatment. FIG. 5B illustrates SEM images of isotropic nanofibers before and after treatment. FIG. 5C illustrates ellipsometry field plots of nanofibers before and after treatment.

FIG. 6 illustrates surface topology analysis of ordered, layered (“checkerboard”) nanofiber mats. FIG. 6A illustrates AFM images of ordered, layered nanofibers before and after treatment. FIG. 6B illustrates SEM images of ordered, layered nanofibers before and after treatment. FIG. 6C illustrates ellipsometry field plots of ordered, layered nanofibers before and after treatment.

FIG. 7 illustrates the improved nanofiber length of nanofibers prepared in a layered, ordered nanofiber mat.

FIG. 8 illustrates the reduced radial volume of the layered, ordered nanofiber mats for various metal and metal oxide nanofibers.

FIG. 9 illustrates the improved electrical conductivity of layered and ordered nanofiber mats.

FIG. 10 illustrates a layered mat comprising aligned nanofibers—with aligned nanofiber segments, including nanofibers with portions thereof that are aligned (1003) and individual nanofibers that are aligned (1004).

### DETAILED DESCRIPTION OF THE INVENTION

Provided herein are high performance nanofibers (e.g., nanofibers comprising high metal content, such as metals, metal oxides, ceramics, metal carbides, or the like) and nanofiber mats (e.g., non-woven mats). Also provided herein are processes for providing nanofibers having high or improved performance. In specific embodiments, the nanofibers or at least a plurality of nanofibers of a nanofiber mat comprise at least one metal component (e.g., metal, metal oxide, metal carbide, ceramic, or combinations thereof).

In certain embodiments, processes for preparing nanofibers described herein comprise:
a. providing a first nanofiber layer, the first nanofiber layer comprising one or more first nanofiber; and
b. providing a second nanofiber layer on top of the first nanofiber layer, the second nanofiber layer comprising one or more second nanofiber.

In certain embodiments, the deposition of the nanofiber layers produce a multilayered nanofiber material (e.g., by providing a first and second nanofiber layer, or by providing a first, second, and third nanofiber, or additional, such as 2-10 or more, layers). In some embodiments, the first nanofibers and the second nanofibers are the same or different. In some embodiments, either or both of the first nanofibers and the second nanofibers comprise a metal reagent component. In specific embodiments, the metal reagent component comprises metal precursor and/or metal, metal oxide, or ceramic nanoparticles.

In some embodiments, a process described herein comprises treating a multilayered nanofiber material, the multilayered nanofiber material comprising a first nanofiber layer and a second nanofiber layer layered on top of the first nanofiber layer. In certain embodiments, the process further comprises treating (e.g., thermally treating) the first and/or second nanofiber layers (or a nanofiber thereof). In certain embodiments, treatment of the first and/or second nanofiber layers (or a nanofiber thereof) (a) carbonizes polymer of the first and/or second nanofiber(s); (b) calcinates the metal reagent component to a metal component (e.g., metal, metal oxide, ceramic, metal carbide, or the like); or (c) both (a) and (b). In some embodiments, nanofibers (e.g., post thermal and/or chemical treatment nanofibers) provided herein comprise at least one metal component (e.g., metal, metal oxide, metal carbide, ceramic, or combinations thereof). In specific embodiments, the metal component comprises at least one metal in an oxidation state of zero or greater (e.g., 0-4). In specific embodiments, the nanofibers are high in metal content (e.g., on an elemental wt % basis).

Provided herein are nanofibers and processes for preparing nanofibers with improved performance properties over other nanomaterials, such as those prepared by sol gel electrospinning, low loading solution electrospinning, nanowire growth, and the like. Further, provided in certain embodiments herein are nanofibers provided herein having improved performance over nanofibers prepared from high loading solution electrospinning that are deposited on a collector in an un-ordered manner.

### Process

In certain embodiments, processes for preparing nanofibers described herein comprise:
a. depositing a first nanofiber layer on a collector, the first nanofiber layer comprising a plurality of first nanofibers; and
b. depositing a second nanofiber layer on top of the first nanofiber layer, the second nanofiber layer comprising a plurality of second nanofibers.

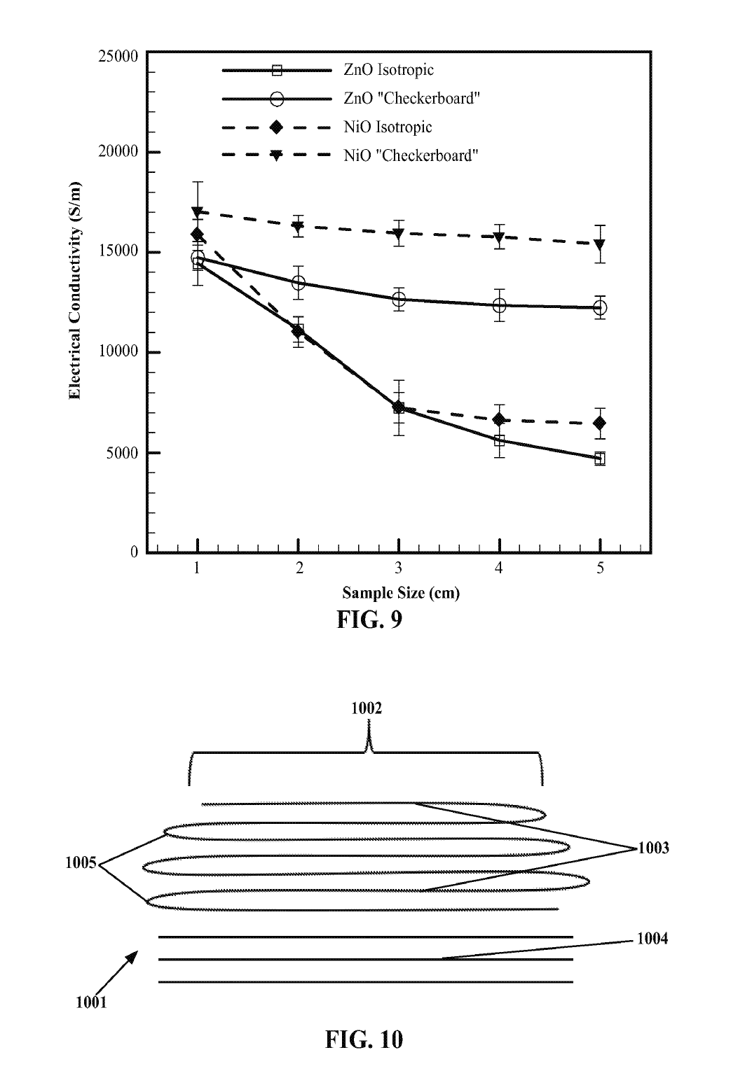

In some embodiments, the first nanofiber(s) of the first nanofiber layer are aligned in a first direction (e.g., a first layer direction comprising the mean and/or median orientation of the first nanofiber(s)). In some embodiments, the second nanofiber(s) of the second nanofiber layer are aligned in a second direction (e.g., a second layer direction having a direction that is the mean and/or median orientation of the second nanofiber(s)). Generally, it is to be understood that a plurality of nanofibers comprises a plurality of nanofiber segments, such as a plurality of aligned nanofiber segments. A plurality of nanofibers or nanofiber segments include, for example, a plurality of individual nanofibers (e.g., that are aligned) and/or one or more nanofiber that comprises a plurality nanofiber segments (e.g., one or more continuous nanofiber comprising a plurality of nanofiber segments that are aligned (e.g., with each other, other segments of additional continuous nanofibers comprising a plurality of aligned segments, and/or individual aligned nanofibers), such as illustrated in FIG. 10).

In some embodiments, the aligned nanofibers are aligned when at least 50% of the nanofibers (e.g., nanofiber segments including individual nanofibers 1004 and/or portions of nanofibers 1003, such as illustrated in FIG. 10, wherein additional segments, such as when portions of the same continuous nanofiber are aligned, are optionally not aligned, such as segments wherein the nanofiber turns around so as to align another segment—e.g., as illustrated by 1005) are aligned within 15 degrees of the direction of the nanofiber layer (which direction is, e.g., the mean and/or median orientation/direction of the nanofibers of the layer). In certain instances, alignment of nanofibers (or segments) (particularly if a continuous nanofiber is used to go back and forth to provide aligned segments, such as illustrated in FIG. 10) is determined by determining the direction of alignment of segments of a specific length (e.g., 1 nm or 10 nm long) within a continuous nanofiber, relative to the adjacent segments to determine the direction of that segment. In certain embodiments, at least 25% of the nanofibers of a layer are aligned within 5 degrees, at least 10 degrees, at least 15 degrees, at last 20 degrees, at least 30 degrees, or the like of the nanofiber layer. In some embodiments, at least 50% of the nanofibers of a layer are aligned within 5 degrees, at least 10 degrees, at least 15 degrees, at last 20 degrees, at least 30 degrees, or the like of the nanofiber layer. In certain embodiments, at least 75% of the nanofibers of a layer are aligned within 5 degrees, at least 10 degrees, at least 15 degrees, at last 20 degrees, at least 30 degrees, at least 45 degrees or the like of the nanofiber layer. In specific embodiments, a plurality of the nanofibers of a layer are aligned in parallel or approximately parallel manner. Similarly, in certain embodiments, provided herein are nanofiber mats with the above alignment (or orientation) wherein the first and/or second nanofibers are treated (e.g., converted to third and/or fourth nanofibers, respectively).

In some embodiments, the first nanofiber layer has a first direction and the second nanofiber layer has a second direction and the first and second directions are oriented at an angle to one another. In some embodiments, the first and second directions are oriented an angle of a 1-90 degree angle to one another. In specific embodiments, the first and second directions are oriented an angle of a 15-90 degree angle to one another. In more specific embodiments, the first and second directions are oriented an angle of a 30-90 degree angle to one another. In still more specific embodiments, the first and second directions are oriented an angle of a 45-90 degree angle to one another. In still more specific embodiments, the first and second directions are oriented approximately orthogonally. Similarly, in certain embodiments, provided herein are nanofiber mats with the above layer alignment wherein the first and/or second nanofibers are treated (e.g., converted to third and/or fourth nanofibers, respectively).

In some embodiments, nanofiber mats comprise at least two layers of nanofibers, at least one layer being a pre-treated nanofiber layer described herein (e.g., a nanofiber (such as a precursor nanofiber) comprising a metal reagent component, such as metal precursor, and polymer, e.g., that following (e.g., thermal and/or chemical) treatment forms metal nanofiber, metal oxide nanofiber, ceramic nanofiber, metal carbide nanofiber, carbon composite nanofiber (e.g., with metal, metal oxide, ceramic, metal carbide, or the like embedded in a carbon matrix)). In further embodiments, nanofiber mats comprise at least three, at least four, at least five, or the like of pre-treated nanofibers. In certain embodiments, nanofiber mats comprise at least two layers of nanofibers, at least one of which is a post treated nanofiber layer. In some embodiments, nanofiber mats comprise at least two layers of post-treated nanofiber layers. In further embodiments, nanofiber mats provided herein comprise at least three layers, at least four layers, at least five layers, or the like of post-treated nanofiber layers (e.g., nanofibers comprising high amounts of metal component). In specific embodiments, the nanofiber within each of such layers are aligned as described herein and the nanofiber layers are aligned relative to one another in a manner as described herein. In some instances, by orienting the nanofiber layers according to the description provided herein, post-treated nanofibers retain improved performance parameters (e.g., continuity, aspect ratio, conductivity, and/or strength) than similarly prepared post-treated nanofibers treated in an isotropic orientation.

In certain embodiments, the nanofibers of a layer are oriented and aligned in any suitable manner. By way of non-limiting example, nanofibers are optionally aligned by: moving an electrospinner in relation to the collector; moving the collector in relation to an electrospinner; manipulating an electrical field between an electrospinner and the collector; utilizing a gas stream to control the movement and deposition of the electrospun nanofiber; flowing a fluid past the deposited nanofibers; aligning the nanofibers with a magnetic field; or any combination thereof. In some embodiments, the collector is a split collector or a rotating drum.

In some embodiments, the first and/or second nanofibers are deposited by electrospinning a fluid stock into a nanofiber layer, the fluid stock comprising (i) a polymer and (ii) a metal reagent component (e.g., (1) metal precursor, (2) nanoparticles of at least one metal component, such as a metal oxide, or (3) a combination thereof). In specific embodiments, the first nanofibers are prepared from a first fluid stock comprising fluid stock comprising (i) a first polymer and (ii) a first metal reagent component and the second nanofibers are prepared from a second fluid stock comprising (i) a second polymer and (ii) a second metal reagent component. In various embodiments, the first and second fluid stocks may be the same or different, the first and second polymers may be the same or different and the first and second metal reagent component(s) may be the same or different. In specific embodiments, the first and second nanofibers are the same. Further, in specific embodiments, the third and fourth nanofibers (e.g., converted from the same first and second first nanofibers) are the same. In some such instances, multiple layers of the same type of nanofiber are layered (e.g., in an ordered manner, wherein each layer is angled relative to adjacent layer(s)), and thermal treatment provides calcination of metal precursor and/or carbonization/removal of organic materials (e.g., polymers and/or precursor ligands).

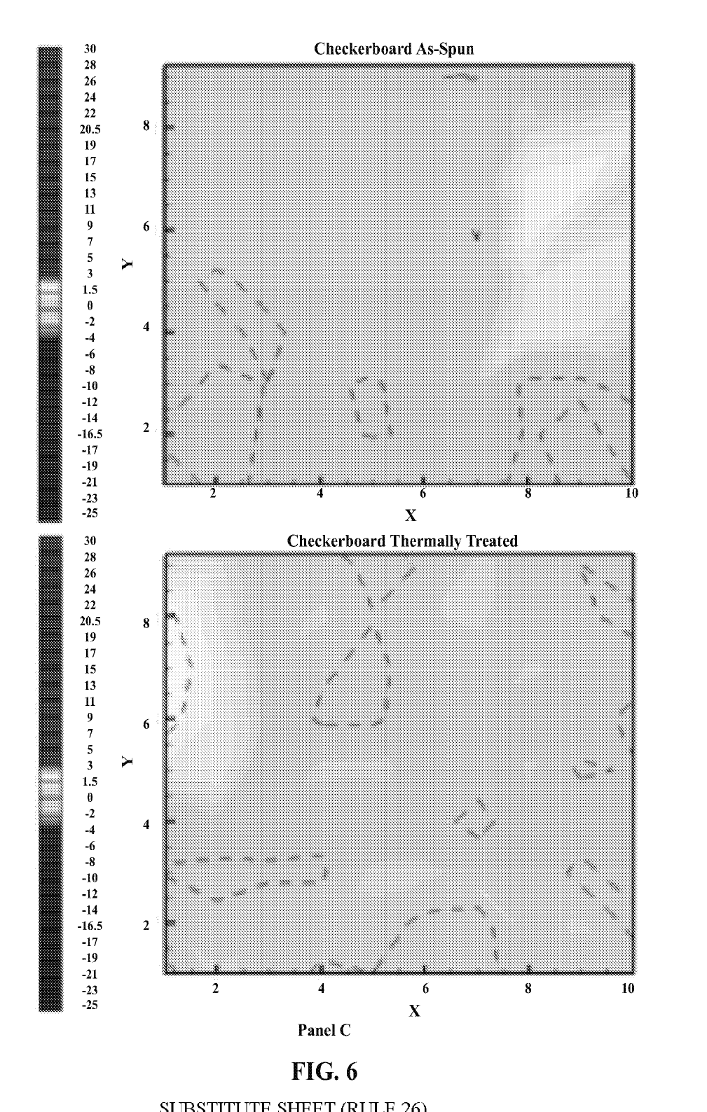

In some embodiments, treatment (e.g., thermal and/or chemical treatment) of first and/or second nanofibers described herein provide third and/or fourth nanofibers (e.g., calcined nanofibers, such as nanofibers having a continuous matrix of metal, metal oxide, ceramic, metal carbide, or the like) with a smaller volume fraction remaining (e.g., comparing the first/second to the third/fourth nanofibers) than would have been obtained from treatment of otherwise identical nanofibers arranged in an isotropic mat (e.g., rather than the ordered layered mats described herein). FIG. 8 illustrates the smaller volume fractions obtained for the ordered layered mats. In some instances, the smaller volume fraction remaining indicate that the volume lost in the ordered layered mats comes from the diameter of the nanofibers, rather than along the length of the nanofiber—indicating greater nanofiber continuity and lower frequency of defects and breaks in the nanofibers. In some embodiments, the volume fraction remaining obtained for third/fourth nanofibers obtained from a process utilizing ordered, layered nanofiber mats (e.g., compared to otherwise identical isotropic mats) is reduced by at least 10%. In more specific embodiments, the volume fraction remaining is reduced by at least 20%. In still more specific embodiments, the volume fraction remaining is reduced by at least 25%.

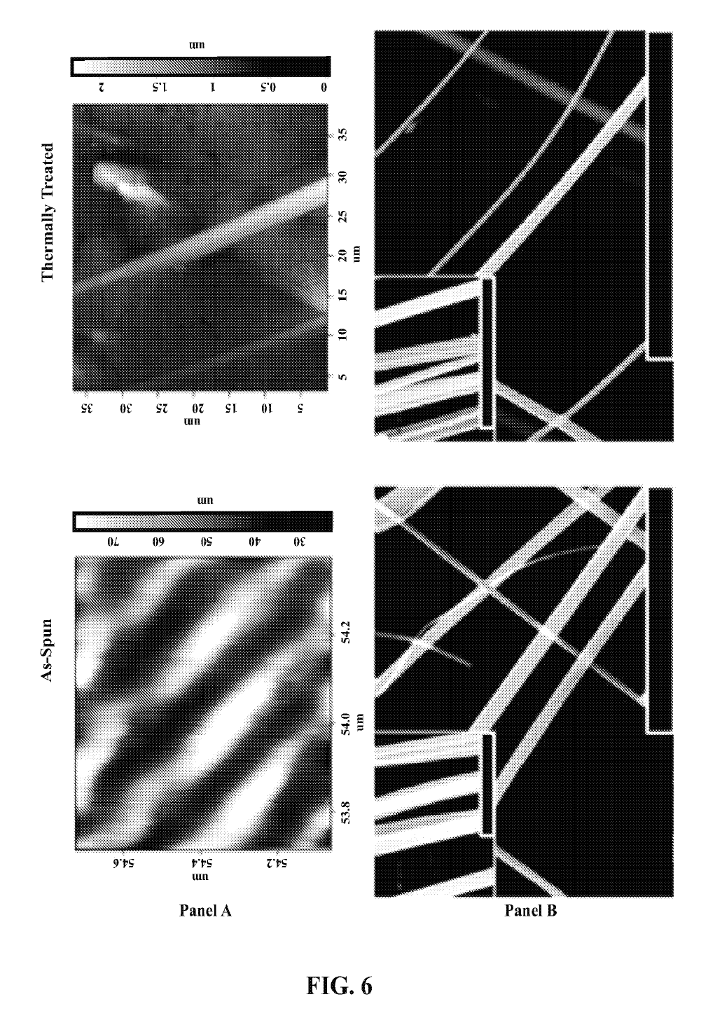

In some embodiments, treatment (e.g., thermal and/or chemical treatment) of first and/or second nanofibers described herein provide third and/or fourth nanofibers (e.g., calcined nanofibers, such as nanofibers having a continuous matrix of metal, metal oxide, ceramic, metal carbide, or the like) with a greater nanofiber length (e.g., comparing the first/second to the third/fourth nanofibers) than would have been obtained from treatment of otherwise identical nanofibers arranged in an isotropic mat (e.g., rather than the ordered layered mats described herein). FIG. 7 illustrates the improved lengths obtained for the ordered layered mats. In some instances, the greater nanofiber length indicates that the volume lost in the ordered layered mats comes from the diameter of the nanofibers, rather than along the length of the nanofiber—indicating greater nanofiber continuity and lower frequency of defects and breaks in the nanofibers. In some embodiments, the average nanofiber length obtained for third/fourth nanofibers obtained from a process utilizing ordered, layered nanofiber mats (e.g., compared to otherwise identical isotropic mats) is increased by at least 5% (e.g., for amorphous nanofibers, such as amorphous ceramic nanofibers—comprising a continuous ceramic matrix—such as alumina). In more specific embodiments, the increase is at least 8%. In still more specific embodiments, the increase is at least 10%. In some embodiments, the average nanofiber length obtained for third/fourth nanofibers obtained from a process utilizing ordered, layered nanofiber mats for ordered, layered nanofiber mats (e.g., compared to otherwise identical isotropic mats) is increased by at least 50% (e.g., for crystalline nanofibers, such as crystalline ceramic, metal oxide, or metal nanofibers). In more specific embodiments, the increase is at least 100%. In still more specific embodiments, the increase is at least 200%.

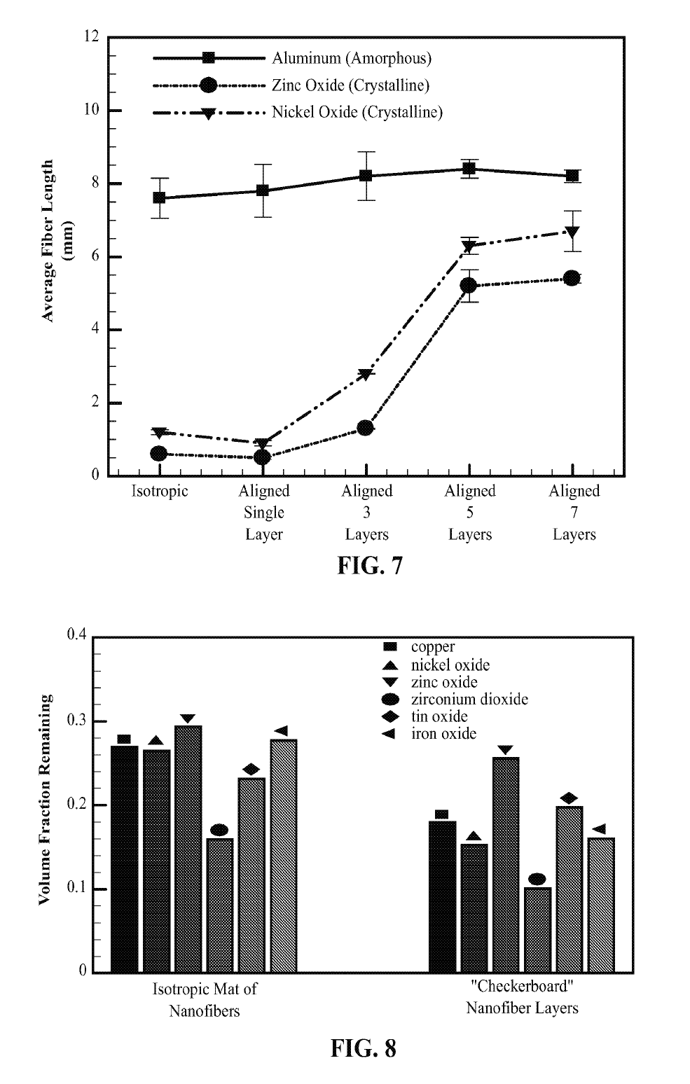

In some embodiments, treatment (e.g., thermal and/or chemical treatment) of first and/or second nanofibers described herein provide third and/or fourth nanofibers (e.g., calcined nanofibers, such as nanofibers having a continuous matrix of metal, metal oxide, ceramic, metal carbide, or the like) with a greater electrical conductivity over greater distances (e.g., comparing the first/second to the third/fourth nanofibers) than would have been obtained from treatment of otherwise identical nanofibers arranged in an isotropic mat (e.g., rather than the ordered layered mats described herein). FIG. 9 illustrates the improved electrical conductivity obtained from the ordered layered mats. In some instances, the greater nanofiber conductivity indicates that the volume lost in the ordered layered mats comes from the diameter of the nanofibers, rather than along the length of the nanofiber—indicating greater nanofiber continuity and lower frequency of defects and breaks in the nanofibers—which provides greater connectivity and conductivity along the nanofiber mat. In some embodiments, the electrical conductivity obtained for third/fourth nanofiber mats obtained from a process utilizing ordered, layered nanofiber mats (e.g., compared to otherwise identical isotropic mats) is increased by at least 10% over at least 3 cm (e.g., 3 cm, 4 cm, or 5 cm) of mat. In more specific embodiments, the increase is at least 25%. In still more specific embodiments, the increase is at least 50%. In yet more specific embodiments, the increase is at least 100%. In further or alternative embodiments, the electrical conductivity for over at least 3 cm (e.g., 3 cm, 4 cm, or 5 cm) of the mat is at least 50% of the electrical conductivity observed over 1 cm of the mat. In specific embodiments, the electrical conductivity for over at least 3 cm (e.g., 3 cm, 4 cm, or 5 cm) of the mat is at least 60% of the electrical conductivity observed over 1 cm of the mat. In more specific embodiments, the electrical conductivity for over at least 3 cm (e.g., 3 cm, 4 cm, or 5 cm) of the mat is at least 75% of the electrical conductivity observed over 1 cm of the mat. Conversely, as illustrated in FIG. 9, in certain instances, isotropically prepared mats are observed to have significant deterioration of electrical conductivity over 3 cm (or more) relative to electrical conductivities measured over 1 cm (e.g., seeing drops in conductivity of over 50%).

In various embodiments, deposition of any one or more of the nanofiber layers comprises electrospining the nanofibers of the layer, interfacial polymerization of the nanofibers of the layer, electro-blowing of the nanofibers of the layer, or a combination thereof. In specific embodiments, depositing the first nanofiber layer comprises electrospinning the first nanofibers and depositing the second nanofiber layer comprises electrospinning the second nanofibers. In some embodiments, the first nanofiber layer is electrospun from a fluid (e.g., an aqueous fluid) composition comprising a first polymer and a first metal precursor. In certain embodiments, the second nanofiber layer is electrospun from a fluid (e.g., aqueous) composition comprising a second polymer and a second metal precursor. In some embodiments, the first and second polymers are the same or different and the first and second metal precursors are the same or different. In certain embodiments, the first and/or second nanofibers are electrospun with a gas stream (e.g., the electrospinning of either or both of the first and second nanofibers is gas assisted electrospinning).

In specific embodiments, the fluid stock(s) comprise at least one metal precursor (e.g., first and second fluid stocks independently comprise at least one metal precursor). In more specific embodiments, one or more fluid stock comprises at least one metal precursor and a plurality of nanoparticles comprising a metal component (e.g., a zero oxidation state metal, a metal oxide, or the like).

In certain embodiments, treatment of some or all of the deposited (e.g., first and/or second) nanofiber(s) comprises thermal treatment thereof. In some embodiments, treatment comprises chemical treatment of the electrospun material. In specific embodiments, chemical treatment comprises treatment with oxidative conditions (e.g., exposure to air, O₂, peroxide, or the like). In some embodiments, oxidative conditions are utilized to convert metal precursor into a metal oxide (e.g., ceramic). In other specific embodiments, chemical treatment comprises treatment with reducing conditions (e.g., exposure to H₂, or the like). In certain embodiments, treatment comprises both thermal and chemical treatment. In some embodiments, treatment is performed under an inert atmosphere (e.g., N₂, Ar, or the like).

In some embodiments, following thermal and/or chemical treatment the first nanofibers are converted to third nanofibers. In specific embodiments, the third nanofibers comprise high metal content (e.g., in the form of zero oxidation state metal or greater than zero oxidation state metal, such as metal oxide or metal carbide), such as a continuous matrix of metal, metal oxide, ceramic, or carbon (with discrete domains comprising high metal content). In certain embodiments, following thermal and/or chemical treatment the second nanofibers are converted to fourth nanofibers. In specific embodiments, the fourth nanofibers comprise high metal content (e.g., in the form of zero oxidation state metal or greater than zero oxidation state metal, such as metal oxide or metal carbide), such as a continuous matrix of metal, metal oxide, ceramic, or carbon (with discrete domains comprising high metal content).

In certain embodiments, the first nanofibers are converted into third nanofibers, the third nanofibers having an average density, average volume and/or average diameter that is less than (e.g., at least 50% less than, at least 40% less than, at least 30%, less than, at least 25% less than, at least 20% less than, at least 15% less than, at least 10% less than, or the like) that of the first nanofibers. In further or alternative embodiments, the second nanofibers are converted into fourth nanofibers, the fourth nanofibers having an average density, average volume and/or average diameter that is less than (e.g., at least 50% less than, at least 40% less than, at least 30%, less than, at least 25% less than, at least 20% less than, at least 15% less than, at least 10% less than, or the like) that of the first nanofibers.

In some embodiments, treatment (e.g., thermal and/or chemical treatment) comprises thermal calcination of metal precursors present in the plurality of first nanofibers, thereby producing a plurality of third nanofibers. In further or alternative embodiments treatment (e.g., thermal and/or chemical treatment) comprises thermal calcination of metal precursors present in the plurality of second nanofibers, thereby producing a plurality of fourth nanofibers. In certain embodiments, treatment (e.g., thermal and/or chemical treatment) comprises degradation and/or removal of polymer present in the plurality of first nanofibers, thereby producing a plurality of third nanofibers. In further or alternative embodiments, treatment (e.g., thermal and/or chemical treatment) comprises degradation and/or removal of polymer present in the plurality of second nanofibers, thereby producing a plurality of fourth nanofibers. In some embodiments, treatment (e.g., thermal and/or chemical treatment) comprises carbonization of polymer present in the plurality of first nanofibers, thereby producing a plurality of third nanofibers. In certain embodiments, treatment (e.g., thermal and/or chemical treatment) comprises carbonization of polymer present in the plurality of second nanofibers, thereby producing a plurality of fourth nanofibers.

In some embodiments, thermal treatment is performed at about 100° C., about 150° C., about 200° C., about 300° C., about 400° C., about 500° C., about 600° C., about 700° C., about 800° C., about 900° C., about 1,000° C., about 1,500° C., about 2,000° C., and the like. In some embodiments, treatment (e.g., calcination) is performed at a temperature of at least 100° C., at least 150° C., at least 200° C., at least 300° C., at least 400° C., at least 500° C., at least 600° C., at least 700° C., at least 800° C., at least 900° C., at least 1,000° C., at least 1,500° C., at least 2,000° C., and the like. In some embodiments, thermal treatment (e.g., calcination) is performed at a temperature of at most 100° C., at most 150° C., at most 200° C., at most 300° C., at most 400° C., at most 500° C., at most 600° C., at most 700° C., at most 800° C., at most 900° C., at most 1,000° C., at most 1,500° C., at most 2,000° C., and the like. In some embodiments, thermal treatment (e.g., calcination) is performed at a temperature of between about 300° C. and 800° C., between about 400° C. and 700° C., between about 500° C. and 900° C., between about 700° C. and 900° C., between about 800° C. and 1,200° C., and the like. In some embodiments, thermal treatment (e.g., calcination) is performed at a constant temperature. In some embodiments, the temperature changes over time. Thermal treatment is performed for any suitable amount of time (e.g., as necessary to arrive at a nanofiber nanostructure with the desired properties). In some instances, treatment (e.g., thermal treatment) of the electrospun nanofiber allows the carbonaceous and organic material to be removed from the resultant treated nanofiber nanostructure. In other instances, treatment (e.g., thermal treatment) of the electrospun nanofiber allows the carbonaceous material (polymer) in proximity to the precursor to react with the precursor, resulting in a metal carbide. In some instances, formation of a carbide is achieved by thermal treatment at a temperature above the temperature required to simply degrade/decompose and remove the organic material (e.g., at a temperature of about 1,000° C. to about 1,700° C.). In more specific embodiments, carbonization of the polymer and reaction of the carbonized polymer with the metal reagent component comprises heating the nanofiber at a temperature suitable to carbonize the polymer and cause the carbonized polymer to react with the metal component. In certain embodiments, the nanofiber is heated to a temperature of about 900° C. to about 2000° C., at least 900° C., at least 1000° C., or the like. In specific embodiments, the nanofiber is heated to a temperature of about 1000° C. to about 1800° C., or about 1000° C. to about 1700° C. In some instances, thermal treatment is performed at a suitable temperature to convert the metal reagent component (e.g., metal precursor) into the metal component and at least partially convert the organic material (e.g., polymer) into a carbon matrix (e.g., an amorphous continuous carbon matrix) (e.g., at a temperature of about 300° C. to about 600° C.). In more specific embodiments, carbonization of the polymer to a continuous carbon matrix comprises heating the nanofiber at a temperature suitable to carbonize the polymer, but not high enough to remove the polymer and/or cause the carbonized polymer to react with the metal or metal reagent component. In certain embodiments, the nanofiber is heated to a temperature of less than 600° C. In specific embodiments, the nanofiber is heated to a temperature of about 200° C. to about 600° C., or about 300° C. to about 550° C.

In some embodiments, treatment is performed at a constant or variable temperature. In some embodiments, the treatment conditions comprise using a temperature gradient. In some embodiments, the temperature increases from a first temperature (e.g., the temperature of the electrospinning process, optionally room temperature) to a second temperature. In certain embodiments, treatment conditions comprise utilization of a temperature increase during the treatment process. In some instances, the rate of temperature increase is any suitable rate, for example about 1° C./min to about 35° C./min. In some embodiments, the treatment occurs for any suitable amount of time. In specific embodiments, the dwell time at the maximum (second) temperature occurs for 10 minutes to 20 hours, or any other suitable amount of time.

In some embodiments, treatment procedures are performed under inert conditions (e.g., under argon or nitrogen). In some instances, treatment procedures are performed under reducing conditions (e.g., under hydrogen, or a mixture of hydrogen and argon). In some embodiments, if a metal component that is a metal is desired, treatment procedures are performed under such reducing or inert conditions. In further embodiments, treatment procedures are performed under oxidative conditions (e.g., under air or other oxygen containing gases). In some embodiments, if a metal component that is a metal oxide or ceramic is desired, treatment procedures are performed under oxidative conditions. In some embodiments, treatment conditions include gaseous conditions, liquid conditions, or the like.

In some instances, a process described herein further comprises electrospinning a second fluid about a common axis with the first fluid stock, whereby electrospinning the first and second fluid together provide the electrospun material. In some instances, common-axial (co-axial) electrospinning of a first and second fluid stock provide a layered hybrid structure, such as one described herein. In some of such instances, the second fluid stock comprises a metal precursor and a polymer in an aqueous medium. In some embodiments, treatment (e.g., thermal and/or chemical treatment) of the precursor material or layer electrospun from the second fluid stock serves to convert the metal precursor into a metal component described herein. Alternatively, the second fluid is a gas, which assists production and drying of an electrospun nanofiber comprising precursor material. Hollow nanofibers are optionally produced by using a second fluid that is a gas and that is electrospun about a common axis with the first fluid and the first fluid is outside the second fluid (i.e., the first fluid is further from the common axis than the second fluid).

In one aspect, the process has a high yield (e.g., which is desirable for embodiments in which the precursor is expensive). In some embodiments, the metal atoms in the nanostructure(s) are about 10%, about 20%, about 30%, about 33%, about 40%, about 50%, about 60%, about 70%, about 80%, about 90%, about 95%, about 98%, or about 100% of the number of (e.g., in moles) metal molecules in the fluid stock (i.e., present in the metal reagent components thereof). In some embodiments, the metal atoms in the nanofibers are at least 10%, at least 20%, at least 30%, at least 33%, at least 40%, at least 50%, at least 60%, at least 70%, at least 80%, at least 90%, at least 95%, at least 98%, or at least 99% of the metal atoms in the fluid stock. In some embodiment, the number of atoms in the nanofibers (e.g., in moles) are between about 10% and about 40%, between about 20% and about 50%, or between about 50% and about 100% of the number of metal atoms (e.g., in moles) in the fluid stock.

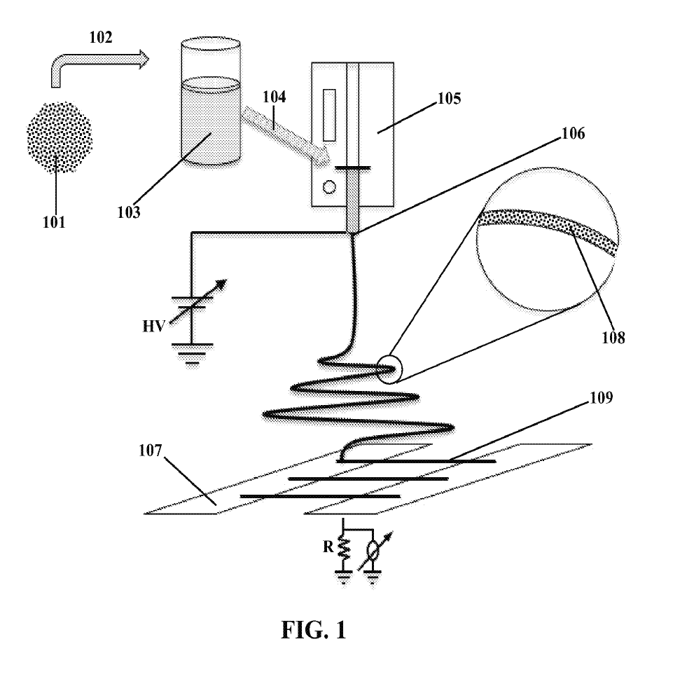

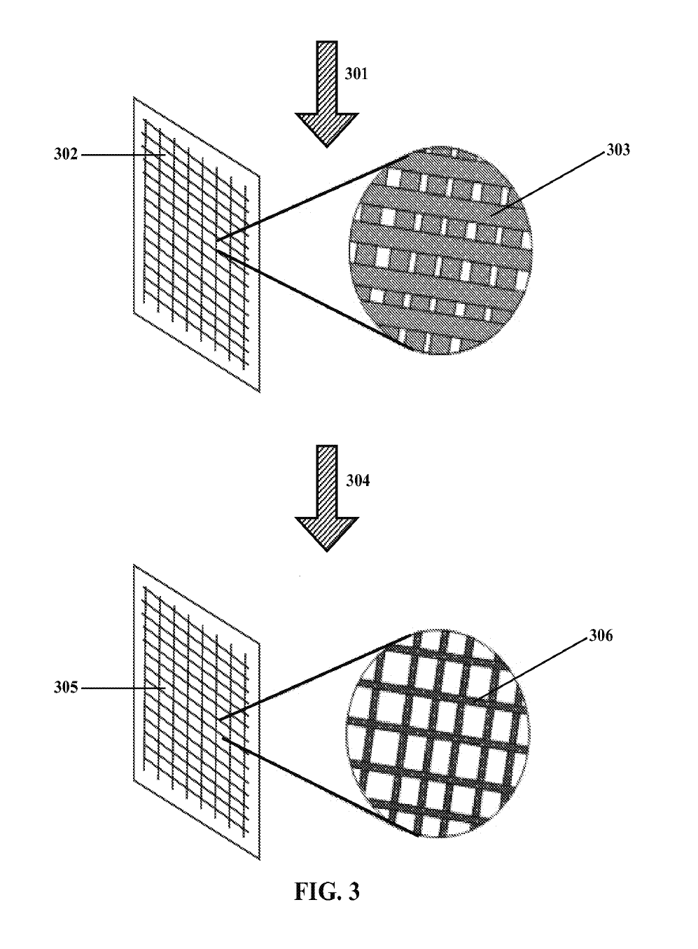

FIG. 1 illustrates an exemplary schematic of a process described herein. In some instances, a first composition comprising metal reagent component 101 (e.g., metal precursor, such as an acetate of Ag, Al, Co, Fe, Ni, Zn, Zr, Si, etc.) is combined 102 with a second composition comprising a polymer 103 (e.g., PVA, PVAc, PEO, etc.) to prepare a fluid stock 104 (e.g., comprising a metal reagent component and polymer—unassociated, partially associated, or completely associated with metal reagent component). In some instances, a fluid stock provided herein is electrospun using an electrospinning apparatus, such as a syringe system 105, through a nozzle 106, wherein the nozzle is optionally heated and may optionally comprise a coaxially aligned gas nozzle for expressing gas along the same longitudinal axis as the fluid stock jet (i.e., the first and/or second nanofibers). In certain embodiments, electrospinning of the fluid stock produces a first nanofiber 108, comprising metal precursor and polymer (e.g., in a weight ratio of precursor to polymer of over 1:2 and up to 4:1), the first nanofiber being collected on a collector 107 (e.g., a split collector). Generally, the first nanofiber is deposited in an ordered layer 109 comprising one or more first nanofiber. FIG. 3 illustrates that in some embodiments, following deposition of the first layer, a second layer of second nanofibers (being the same or different from the first nanofibers of the first layer) is deposited 301 on top of the first layer, forming a multilayered nanofiber material comprising deposited nanofibers 302. In certain embodiments, the second layer is generally aligned in a non-parallel manner relative to the first layer (e.g., the first mean or first median direction of the first nanofiber(s) is not parallel to the second mean or second median direction of the second nanofiber(s)). In specific instances, the nanofibers of the second layer are aligned in an approximately orthogonal manner to the first layer 303. Following thermal treatment 304, the multilayered nanofiber material comprising deposited nanofibers 302 is converted to a multilayered nanofiber comprising treated nanofibers 305, e.g., wherein first nanofibers are optionally converted to third nanofibers (e.g., wherein the polymer has been carbonized or removed and the metal reagent component has been converted to a metal component) and the second nanofibers are optionally converted to fourth nanofibers (e.g., wherein the polymer has been carbonized or removed and the metal reagent component has been converted to a metal component). In some embodiments, wherein the first nanofibers are converted to third nanofibers and the second nanofibers are converted to fourth nanofibers following treatment (e.g., thermal and/or chemical treatment), the nanofibers of the multilayered nanofiber material produced 306 have a smaller average diameter than the pre-treated nanofibers 303. Moreover, in some instances, this layered deposition approach provides nanofibers that are narrower, longer, and less likely to be frayed than nanofibers produced via isotropic deposition techniques.

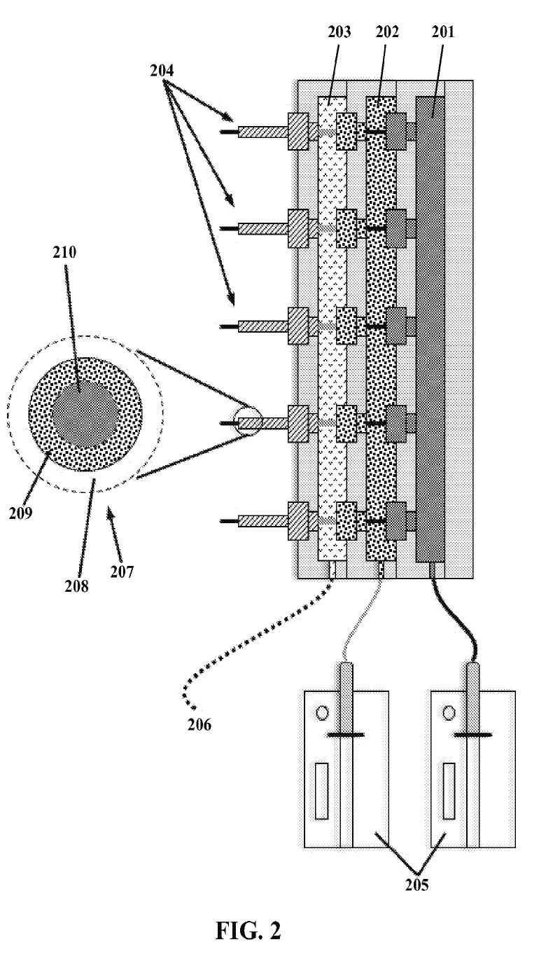

FIG. 2 illustrates an exemplary schematic of a process or apparatus described herein, particularly for preparing a layered nanocomposite nanofibers by a coaxial gas assisted electrospinning process. In some instances, a first fluid stock 201 (e.g., comprising a metal reagent component and a polymer), is electrospun with an optional second fluid stock 202 (e.g., comprising a second metal precursor and a second polymer, the second precursor and polymer independently being either the same or different from the first), and a third fluid (e.g., gas) 203. The fluid stocks may be provided to the apparatus by any device, e.g., by a syringe 205. And the gas may be provided from any source 206 (e.g., air pump). In some embodiments such an apparatus comprises a plurality of co-axial needles 204. Exemplary needles, as illustrates by the cross section 207, comprise an outer sheath tube 208 (e.g., having a supply end and a nozzle end), at least one intermediate tube 209 (e.g., having a supply end and a nozzle end), and a core tube 210 (e.g., having a supply end and a nozzle end). In specific instances, each of the tubes are coaxially aligned (i.e., aligned along the substantially same axis). In certain embodiments, such a process may be utilized to prepare a nanofiber comprising a core and a layer. In some embodiments, the intermediate tube may be absent and a fluid stock may be electrospun in a gas-assisted manner (i.e., the sheath tube provides a high velocity gas). In other embodiments, the fluid stock may be electrospun from the sheath tube, the intermediate tube may be absent and the gas may be provided from the core tube (e.g., to produce a hollow nanofiber, which may be further treated/processed according to the techniques described herein to produce a hollow carbonaceous nanofiber). In some instances, the tube or nozzle end of any tube (e.g., any tube providing a fluid stock is) heated or capable of being heated. In some instances, heating of the nozzle provides for improved electrospinning performance and/or electrospun nanofiber morphology.

Fluid Stock/Deposited Nanofiber Components

In some embodiments, one or more of the deposited nanofibers (e.g., the first and/or second nanofibers) are prepared from a fluid stock into a nanofiber layer, the fluid stock comprising (i) a polymer and (ii) a metal reagent component (e.g., (1) metal precursor, (2) nanoparticles of at least one metal component, such as a metal oxide, or (3) a combination thereof). In specific embodiments, one or more of the fluid stock(s) comprise an aqueous medium. In some embodiments, the fluid stock comprises at least one metal precursor in association with one or more of the at least one polymer.

In some embodiments, high loading of metal reagent component (e.g., concentration and/or relative to polymer) and homogeneity in fluid stocks and/or deposited nanofibers facilitate and/or provide pure and/or uniform nanofibers following treatment. In certain instances, few defects and/or voids are created in the nanofiber when upon treatment compared to the number of defects and/or voids created when having lower precursor loading.

In various embodiments, a fluid stock comprises a substantially uniform and/or homogenous dispersion or solution (e.g., as measured by viscosity deviations, UV absorbance, or the like). In some embodiments, a fluid stock is aqueous (i.e., comprises water). In certain instances, use of water in the fluid stock facilitates the dispersion of the metal reagent component (e.g., metal precursor), facilitates forming metal reagent component-polymer associations in the fluid stock, and facilitates forming a uniform and/or homogenous dispersion/solution.

In some embodiments, the fluid stock uniform or homogenous. In specific embodiments, the process described herein comprises maintaining fluid stock uniformity or homogeneity. In some embodiments, fluid stock uniformity and/or homogeneity is achieved or maintained by any suitable mechanism, e.g., by agitating, heating, or the like. Methods of agitating include, by way of non-limiting example, mixing, stirring, shaking, sonicating, or otherwise inputting energy to prevent or delay the formation of more than one phase in the fluid stock. In some embodiments, the fluid stock is continually agitated. In some embodiments, the fluid stock is agitated to create a uniform dispersion or solution, which is then used in an electrospinning step before the fluid stock (e.g., dispersion or solution) loses uniformity and/or homogeneity (e.g., it before it separates into more than one phase).

In some embodiments, a fluid stock is prepared by (i) dissolving or dispersing a metal reagent (e.g., precursor) in a first fluid (e.g., water, or another aqueous medium) to form a first composition; (ii) dissolving or dispersing a polymer in a second fluid (e.g., water, or another aqueous medium) to form a second composition; and (iii) combining at least a portion of the first and second compositions to form the fluid stock. The first and second fluid stocks may be the same or different (and the first and second nanofibers may be the same or different). Descriptions of fluid stocks herein are intended to describe one or more of the fluid stocks used in the processes described herein. Fluid stocks described herein optionally and independently comprise the components and characteristics described herein.

In some embodiments, a fluid stock provided herein is prepared by combining a metal reagent component and a polymer in an aqueous medium (e.g., in water). In some embodiments, a metal reagent component is combined with the polymer in a metal reagent component to polymer weight-to-weight ratio of at least 1:2 (e.g., at least 1:1). In certain embodiments, a first metal reagent component is combined with a polymer, forming an association (e.g., via a ligand replacement reaction) between the polymer and a second metal reagent component (e.g., a metal-ligand complex wherein one of the ligands of the first metal reagent component is replaced with a polymer moiety). In some embodiments, a fluid stock provided herein may comprise both first and second metal reagent components (e.g., polymer-associated and non-associated metal reagent components). For the purposes of concentration and embodiments herein, reference to a metal reagent component encompasses any metal reagent component present in the fluid stock, whether it is associated with the polymer or not. Similarly, polymer concentration and embodiments provided herein encompass polymer in associated and non-associated forms. Reference to the polymer refers only to the polymer moiety of such an association, and reference to the precursor refers to the precursor moiety of such an association. In some instances such an association process may be complete (i.e., all metal reagent precursor and/or polymer reactive sites may be associated), and in other instances, some of the metal reagent precursor and/or polymer reactive sites (e.g., —OH groups for the PVA) may remain unassociated. In other words, in some instances, x hydroxyl groups of the PVA may be associated with the precursor, and n-x hydroxyl groups may remain unassociated. Such associations may be monitored in any suitable manner, e.g., by infrared (IR) spectrometry, nuclear magnetic resonance (NMR) spectrometry, mass spectrometry (MS, e.g., GCMS), or the like.

In some aspects, the polymer is soluble in water, meaning that it forms a solution in water. In other embodiments, the polymer is swellable in water, meaning that upon addition of water to the polymer the polymer increases its volume up to a limit. Water soluble or swellable polymers are generally at least somewhat hydrophilic. In some embodiments, a polymer described herein is a polymer that is electrophilic or nucleophilic. In some instances, a nucleophilic or electrophilic polymer is matched with a complementary precursor (e.g., a nucleophilic polymer, such as PVA, is matched with a electrophilic precursor, such as a metal acetate). Exemplary polymers suitable for the present methods include but are not limited to polyvinyl alcohol (“PVA”), polyvinyl acetate (“PVAc”), polyethylene oxide (“PEO”), polyvinyl ether, polyvinyl pyrrolidone, polyglycolic acid, hydroxyethylcellulose (“HEC”), ethylcellulose, cellulose ethers, polyacrylic acid, polyisocyanate, and the like. In some embodiments, the polymer is isolated from biological material. In some embodiments, the polymer is starch, chitosan, xanthan, agar, guar gum, and the like.

In some embodiments, a polymer described herein (e.g., in a process, deposited nanofiber, a fluid stock, or the like) is a polymer (e.g., homopolymer or copolymer) comprising a plurality of reactive sites. In certain embodiments, the reactive sites are nucleophilic (i.e., a nucleophilic polymer) or electrophilic (i.e., an electrophilic polymer). For example, in some embodiments, a nucleophilic polymer described herein comprises a plurality of alcohol groups (such as polyvinyl alcohol—PVA—or a cellulose), ether groups (such as polyethylene oxide—PEO—or polyvinyl ether—PVE), and/or amine groups (such as polyvinyl pyridine, ((di/mono)alkylamino)alkyl alkacrylate, or the like).

In certain embodiments, the polymer is a nucleophilic polymer (e.g., a polymer comprising alcohol groups, such as PVA). In some embodiments, the polymer is a nucleophilic polymer and a first precursor (e.g., reagent precursor) is an electrophilic precursor (e.g., a metal acetate, metal chloride, or the like). In specific embodiments, the precursor-polymer association is a reaction product between a nucleophilic polymer and an electrophilic first precursor (e.g., reagent precursor).

In other embodiments, the polymer is an electrophilic polymer (e.g., a polymer comprising chloride or bromide groups, such as polyvinyl chloride). In some embodiments, the polymer is an electrophilic polymer and a first precursor (e.g., reagent precursor) is a nucleophilic precursor (e.g., metal-ligand complex comprising “ligands” with nucleophilic groups, such as alcohols or amines). In specific embodiments, the precursor-polymer association is a reaction product between an electrophilic polymer and a nucleophilic first precursor.

In some embodiments, the polymer imparts a suitable elongational viscosity to the fluid stock for electrospinning nanofibers. In some embodiments, low shear viscosity leads to beaded nanofibers. In one aspect, uniform distribution of the precursor in the fluid feed helps to maintain a suitably high elongational viscosity.

Generally, a fluid stock provided herein has a fluidity and viscosity suitable for electrospinning. In some embodiments, a fluid stock provided herein is a solution, a dispersion, or the like. In specific embodiments, a or all fluid stocks used in a process herein are aqueous fluid stocks (with optional gas fluid(s) also electrospun about a common axis). Viscosity is a measure of the resistance of a fluid which is being deformed by either shear stress or tensile stress. Viscosity is measured in units of poise. In various embodiments, the viscosity of the polymer or fluid stock is measured with or without associated precursor. The polymer or fluid stock has any suitable elongational viscosity. In some embodiments, a polymer or fluid stock used according to the disclosure herein has an elongational viscosity of about 50 poise, about 100 poise, about 200 poise, about 300 poise, about 400 poise, about 500 poise, about 600 poise, about 800 poise, about 1000 poise, about 1500 poise, about 2000 poise, about 2500 poise, about 3000 poise, about 5,000 poise, and the like. In some embodiments, the polymer or fluid stock has an elongational viscosity of at least 50 poise, at least 100 poise, at least 200 poise, at least 300 poise, at least 400 poise, at least 500 poise, at least 600 poise, at least 800 poise, at least 1,000 poise, at least 1,500 poise, at least 2,000 poise, at least 2,500 poise, at least 3,000 poise, at least 5,000 poise, and the like. In some embodiments, the polymer or fluid stock has an elongational viscosity of at most 50 poise, at most 100 poise, at most 200 poise, at most 300 poise, at most 400 poise, at most 500 poise, at most 600 poise, at most 800 poise, at most 1,000 poise, at most 1,500 poise, at most 2,000 poise, at most 2,500 poise, at most 3,000 poise, at most 5,000 poise, and the like. In some embodiments, the polymer or fluid stock has an elongational viscosity of between about 100 and 3,000 poise, or between about 1,000 and 5,000 poise, and the like.

Molecular weight is related to the mass of the monomers comprising the polymer and the degree of polymerization. In some embodiments, molecular weight is a factor that affects viscosity. The polymer has any suitable molecular weight. In some embodiments, the polymer has a molecular weight of at least 20,000 atomic mass units (“amu”), at least 50,000 amu, at least 100,000 amu, at least 200,000 amu, at least 300,000 amu, at least 400,000 amu, at least 500,000 amu, at least 700,000 amu, or at least 1,000,000 amu and the like. In some embodiments, the polymer has a molecular weight of at most 20,000 amu, at most 50,000 amu, at most 100,000 amu, at most 200,000 amu, at most 300,000 amu, at most 400,000 amu, at most 500,000 amu, at most 700,000 amu, or at most 1,000,000 amu and the like. In some embodiments, the polymer has a molecular weight of about 20,000 amu, about 50,000 amu, about 100,000 amu, about 200,000 amu, about 300,000 amu, about 400,000 amu, about 500,000 amu, about 700,000 amu, or about 1,000,000 amu and the like. In yet other embodiments, the polymer has a molecular weight of from about 50,000 amu to about 1,00,000 amu, from about 100,000 amu to about 500,000 amu, from about 200,000 amu to about 400,000 amu, or from about 500,000 amu to about 1,00,000 amu and the like.

The polydispersity index (“PDI”) is a measure of the distribution of molecular mass in a given polymer sample. The PDI is the weight average molecular weight divided by the number average molecular weight, which is calculated by formula known to those skilled in the art of polymer science. The polymer has any suitable polydispersity index. In some embodiments, the polymer has a polydispersity index of about 1, about 2, about 3, about 4, about 5, about 6, about 7, about 8, about 9, about 10, about 15, about 20, and the like. In some embodiments, the polymer has a polydispersity index of at least 1, at least 2, at least 3, at least 4, at least 5, at least 6, at least 7, at least 8, at least 9, at least 10, at least 15, at least 20, and the like. In some embodiments, the polymer has a polydispersity index of at most 1, at most 2, at most 3, at most 4, at most 5, at most 6, at most 7, at most 8, at most 9, at most 10, at most 15, at most 20, and the like. In some embodiments, the polymer has a polydispersity index of about 1 to about 10, about 2 to about 5, and the like.

In some examples, high loading of precursor on the polymer in the fluid stock is beneficial for obtaining pure and/or uniform nanofibers. As described herein, few defects and/or voids are created in the nanofiber when the polymer is removed compared to the number of defects and/or voids created when having lower precursor loading. In some instances, loading is represented as the weight ratio of the metal reagent component to polymer in the fluid stock or deposited nanofiber (the metal reagent component being in associated and/or non-associated form). The weight ratio of the metal reagent component to polymer is any value resulting in a nanofiber with suitable properties in a given embodiment. The weight ratio of the metal reagent component to polymer is at least 1:2 in some embodiments. In other embodiments, the ratio is at least 1:3, at least 1:2, at least 1:1.75, at least 1:1.5, or at least 1:1.25. In other embodiments there is about equal weights of metal reagent component and polymer. In some embodiments, there is more metal reagent component than polymer by weight. In some embodiments, the weight ratio of the metal reagent component to polymer is at least 1.25:1, at least 1.5:1, at least 1.75:1, at least 2:1, at least 3:1, or at least 4:1. In yet other embodiments, the weight ratio of metal reagent component to polymer is about 1:2 to about 5:1, or about 1:1 to about 4:1. In some embodiments, all or part of the metal reagent component is associated with the polymer and the metal reagent component to polymer weight-to-weight ratio is determined by the ratio of the sum of the associated and non-associated metal reagent component to the polymer.

A fluid stock comprising a polymer may comprise any suitable amount of polymer. The weight percent of polymer in the fluid stock is represented as the weight percent of polymer (whether the polymer is associated with metal reagent or not). In some embodiments, the fluid stock comprises at least about 0.5 weight %, at least about 1 weight %, at least about 2 weight %, at least about 3 weight %, at least about 4 weight %, at least about 5 weight %, at least about 6 weight %, at least about 7 weight %, at least about 8 weight %, at least about 9 weight %, at least about 10 weight %, at least about 12 weight %, at least about 14 weight %, at least about 16 weight %, at least about 18 weight %, at least about 20 weight %, at least about 30 weight %, or at least about 40 weight % polymer. In some embodiments, the fluid stock comprises from about 1 weight % to about 20 weight % polymer. In some embodiments, the fluid stock comprises from about 1 weight % to about 10 weight %, from about 1 weight % to about 5 weight %, from about 5 weight % to about 20 weight %, from about 5 weight % to about 10 weight %, from about 10 weight % to about 15 weight %, or from about 15 weight % to about 20 weight % polymer.

In certain embodiments, polymer concentration in the fluid stock is determined on a monomeric residue concentration. In other words, the concentration of the polymer is determined based on the concentration of polymeric repeat units present in the stock. For example, polymer concentration of polyvinyl alcohol may be measured based on the concentration of (—CH₂CHOH—) present in the fluid stock. In some embodiments, the monomeric residue (i.e., repeat unit) concentration of the polymer in the fluid stock is at least 100 mM. In specific embodiments, the monomeric residue (i.e., repeat unit) concentration of the polymer in the fluid stock is at least 200 mM. In more specific embodiments, the monomeric residue (i.e., repeat unit) concentration of the polymer in the fluid stock is at least 400 mM. In still more specific embodiments, the monomeric residue (i.e., repeat unit) concentration of the polymer in the fluid stock is at least 500 mM. In at least 5 mM, at least 100 mM, at least 150 mM, at least 200 mM, at least 250 mM, at least 300 mM, at least 350 mM, at least 400 mM, at least 500 mM, at least 700 mM, at least 900 mM, at least 1.2 M, at least 1.5 M, at least 2 M, at least 5 M, and the like. In some embodiments, the concentration of the monomeric residue in the fluid stock is between 5 mM and 5 M, between 200 mM and 1 M, between 100 mM and 700 mM, and the like. In some embodiments, the concentration of metal reagent (e.g., precursor) in the fluid stock to monomeric residue in the fluid stock is at least 1:4. In specific embodiments, the concentration of metal reagent (e.g., precursor) in the fluid stock to monomeric residue in the fluid stock is at least 1:3. In more specific embodiments, the concentration of metal reagent (e.g., precursor) in the fluid stock to monomeric residue in the fluid stock is at least 1:2. In still more specific embodiments, the concentration of metal reagent (e.g., precursor) in the fluid stock to monomeric residue in the fluid stock is at least 1:1.2. In yet more specific embodiments, the concentration of metal reagent (e.g., precursor) in the fluid stock to monomeric residue in the fluid stock is about 1:1 (e.g., within 5%). In other embodiments, the concentration of metal reagent (e.g., precursor) in the fluid stock to monomeric residue in the fluid stock is at least 1:10, at least 1:8, at least 1:6, at least 1:1.5, at least 1:3.5, at least 1:2.5, or any suitable ratio.

In some embodiments, a fluid stock described herein comprises metal reagent (e.g., precursor) and polymer, wherein at least 5 elemental wt. % of the total mass of the metal reagent (e.g., precursor) and polymer is metal. In certain embodiments, at least 10 elemental wt. % of the total mass of the metal reagent (e.g., precursor) and polymer is metal. In specific embodiments, at least 15 elemental wt. % of the total mass of the metal reagent (e.g., precursor) and polymer is metal. In more specific embodiments, at least 20 elemental wt. % of the total mass of the metal reagent (e.g., precursor) and polymer is metal. In specific embodiments, at least 25 elemental wt. % of the total mass of the metal reagent (e.g., precursor) and polymer is metal. In still more specific embodiments, at least 30 elemental wt. % of the total mass of the metal reagent (e.g., precursor) and polymer is metal. In yet more specific embodiments, at least 35 elemental wt. % of the total mass of the metal reagent (e.g., precursor) and polymer is metal. In more specific embodiments, at least 40 elemental wt. % of the total mass of the metal reagent (e.g., precursor) and polymer is metal. In various embodiments, at least 10 elemental wt. %, at least 15 elemental wt. %, at least 45 elemental wt. %, at least 50 elemental wt. % of the total mass of the metal reagent (e.g., precursor) and polymer is metal.

In one aspect, the concentration of metal reagent (e.g., precursor) in a fluid stock is high. The concentration is any suitable concentration. In some embodiments, the concentration of the metal reagent (e.g., precursor) in the fluid stock is about 5 mM, about 10 mM, about 20 mM, about 40 mM, about 60 mM, about 80 mM, about 100 mM, about 150 mM, about 200 mM, about 250 mM, about 300 mM, about 350 mM, about 400 mM, about 500 mM, about 700 mM, about 900 mM, about 1.2 M, about 1.5 M, about 2 M, about 5 M, and the like. In some embodiments, the concentration of the metal reagent (e.g., precursor) in the fluid stock is at least 5 mM, at least 10 mM, a at least 20 mM, at least 40 mM, at least 60 mM, at least 80 mM, at least 100 mM, at least 150 mM, at least 200 mM, at least 250 mM, at least 300 mM, at least 350 mM, at least 400 mM, at least 500 mM, at least 700 mM, at least 900 mM, at least 1.2 M, at least 1.5 M, at least 2 M, at least 5 M, and the like. In some embodiments, the concentration of the metal reagent (e.g., precursor) in the fluid stock is between 5 mM and 5 mM, between 20 mM and 1 M, between 100 mM and 700 mM, between 100 mM and 300 mM, and the like.

In some embodiments, the fluid stock and/or deposited nanofiber comprises a high loading of metal reagent component. In some embodiments, the polymer is at least 20% loaded with metal reagent component (i.e., at least 20% of the reactive sites of the polymer are associated with a metal reagent component). In specific embodiments, the polymer is at least 35% loaded with metal reagent component. In more specific embodiments, the polymer is at least 50% loaded with metal reagent component. In still more specific embodiments, the polymer is at least 75% loaded with metal reagent component. In various embodiments, the polymer is at least 20%, at least at least 30%, at least 40%, at least 50%, at least 60%, at least 70%, at least 75%, at least 80%, at least 85%, at least 85%, at least 90%, at least 95%, at least 96%, at least 97%, at least 98%, or at least 99% loaded with metal reagent component. In some instances, the polymer is about 50% to 100%, about 70% to 100%, about 90% to 100%, about 50% to about 90%, about 60% to about 80%, or about 20% to about 50% loaded with metal reagent component. In some embodiments, the metal reagent component present in a fluid stock or deposited nanofiber is at least 80% associated with the polymer. In more specific embodiments, the precursor present in a fluid stock or deposited nanofiber is at least 90% associated with the polymer. In still more specific embodiments, the precursor present in a fluid stock or deposited nanofiber is at least 95% associated with the polymer. In other specific embodiments, the precursor present in a fluid stock or deposited nanofiber is at least 20%, at least 30%, at least 40%, at least 50%, at least 60%, at least 70%, at least 75%, at least 85%, at least 98%, or at least 99% associated with the polymer. Loading and/or association between metal reagent component and polymer can be determined in any suitable manner, e.g., with nuclear magnetic resonance (NMR) spectrometry, infrared (IR) spectrometry, or the like.

Any suitable precursor is optionally utilized in any processes described herein. In some embodiments, the precursor is a metal-ligand (e.g., complex, salt, or the like). In some embodiments, precursors include metal associations with acetate, iodide, bromide, sulfide, thiocyanate, chloride, nitrate, azide, fluoride, hydroxide, oxalate, water, nitrite, isothiocyanate, acetonitrile, pyridine, ammonia, ethylenediamine, 2,2′-bipyridine, 1,10-phenanthroline, nitrite, triphenylphosphate, cyanide, carbon monoxide, or alkyl-oxide. In specific examples, the precursor is a metal-ligand such as metal acetate (e.g., Al(OCOCH₃)₃), metal chloride, metal nitrate, or metal alkyl-oxide. In specific embodiments, the metal precursor is a metal-ligand association (complex) (e.g., a coordination complex), each metal precursor comprising metal atom(s) associated (complexed) with one or more ligand(s) (e.g., 1-10, 2-9, or any suitable number of ligands). In specific embodiments, the precursor described herein comprises at least two different types of ligand (e.g., at least one acetate and at least one halide). In some embodiments, the precursor is a metal carboxylate (e.g., —OCOCH₃ or another —OCOR group, wherein R is an alkyl, substituted alkyl, aryl, substituted aryl, or the like). In certain embodiments, the precursor is a metal nitrate. In some embodiments, the precursor is a metal alkoxide (e.g., a methoxide, ethoxide, isopropyl oxide, t-butyl oxide, or the like). In some embodiments, the precursor is a metal halide (e.g., chloride, bromide, or the like). In certain embodiments, the precursor is a diketone (e.g., acetylacetone, hexafluoroacetylacetone, or the like). In other embodiments, any suitable ligand may be utilized in a metal-ligand association (metal precursor) described herein, e.g., ketones, diketones (e.g., a 1,3-diketone, such as ROCCHR′COR group, wherein R is an alkyl, substituted alkyl, aryl, substituted aryl and R′ is R or H), carboxylates (e.g., acetate or —OCOR group, wherein each R is independently an alkyl, substituted alkyl, aryl, substituted aryl), halides, nitrates, amines (e.g., NR′₃, wherein each R″ is independently R or H or two R″, taken together form a heterocycle or heteroaryl), and combinations thereof. Further examples include iodide, bromide, sulfide (e.g., —SR), thiocyanate, chloride, nitrate, azide, fluoride, hydroxide, oxalate, water, nitrite (e.g., RN₃), isothiocyanate, acetonitrile, pyridine, ammonia, ethylenediamine, 2,2′-bipyridine, 1,10-phenanthroline, nitrite, triphenylphosphate, cyanide, carbon monoxide, or alko-oxide. Metals for such metal reagent components (e.g., metal precursors) are any suitable metal, including those as described herein for the metal component.

In some instances, there is some cross-linking between polymers, e.g., through a metal reagent component. In some embodiments, the polymers of a fluid stock or deposited nanofiber described herein are less than 20% cross-linked (e.g., less than 20% of the metal reagent component are associated with 2 or more polymers and/or less than 20% of the monomeric units of the polymer are connected, e.g., via a metal reagent component, to another polymer). In some embodiments, the polymers are less than 10% cross-linked. In specific embodiments, the polymers are less than 5% cross-linked. In more specific embodiments, the polymers are less than 3% cross-linked. In still more specific embodiments, the polymers are less than 2% cross-linked. In yet more specific embodiments, the polymers are less than 1% cross-linked.

In some embodiments, one or more types of deposited nanofibers (e.g., first and/or second nanofibers) (e.g., pre-treatment nanofibers) provided herein comprise a polymer and (e.g., on average) at least 5 elemental wt. % metal. In certain embodiments, one or more types of deposited nanofibers provided herein comprise a polymer and (e.g., on average) at least 10 elemental wt. % metal. In specific embodiments, one or more types of deposited nanofibers provided herein comprise a polymer and (e.g., on average) at least 15 elemental wt. % metal. In more specific embodiments, one or more types of deposited nanofibers provided herein comprise a polymer and (e.g., on average) at least 20 elemental wt. % metal. In specific embodiments, metal constitutes (e.g., on average) at least 25 elemental wt. % one or more types of deposited nanofiber(s). In still more specific embodiments, metal constitutes (e.g., on average) at least 30 elemental wt. % of one or more types of deposited nanofiber(s). In yet more specific embodiments, metal constitutes (e.g., on average) at least 35 elemental wt. % of one or more types of deposited nanofiber(s). In more specific embodiments, metal constitutes (e.g., on average) at least 40 elemental wt. % of one or more types of deposited nanofiber(s). In various embodiments, metal constitutes (e.g., on average) at least 10 elemental wt. %, at least 15 elemental wt. %, at least 45 elemental wt. %, at least 50 elemental wt. % of one or more types of deposited nanofiber(s).

In some embodiments, one or more types of deposited nanofiber comprises metal reagent component and polymer, wherein the metal reagent component and polymer when taken together make up at least 50%, at least 60%, at least 70%, at least 80%, at least 90%, at least 95%, or at least 98% of the total mass of the nanofiber.

In some instances, a process of preparing treated nanofibers may leave defects such as gaps, voids, and the like in the treated nanofiber. In some embodiments, these defects are reduced by increasing the proportion of metal reagent component in the fluid stock and/or deposited nanofiber relative to the amount of polymer. In some embodiments, increasing homogeneity of the fluid stock reduces the voids and/or defects in the treated nanofiber compared to when the fluid stock is not homogenous. In some instances, when the fluid feed is electrospun and converted to a treated nanofiber, use of homogenous fluid feed leads to a homogenous deposited and/or treated nanofiber.

In some embodiments, associating the precursor with the polymer, such as through a chemical bond between the precursor and polymer results in long, high quality treated nanofibers with few defects compared to embodiments without an association between the precursor and polymer. In some instances, the precursor is distributed relatively homogenously on the polymer (e.g., such that electrospinning of the fluid stock having such homogenous associations provides nanofibers with few voids and defects). In addition to the association, it is advantageous in some embodiments to first create a homogenous solution of precursor before combining the precursor and polymer.

### Electrospinning

In some embodiments, the process comprises electrospinning a fluid stock. Any suitable method for electrospinning is used. In some instances, elevated temperature electrospinning is utilized. Exemplary methods for comprise methods for electrospinning at elevated temperatures as disclosed in U.S. Pat. No. 7,326,043 and U.S. Pat. No. 7,901,610, which are incorporated herein for such disclosure. In some embodiments, elevated temperature electrospinning improves the homogeneity of the fluid stock throughout the electrospinning process. In some embodiments, gas assisted electrospinning is utilized (e.g., about a common axis with the jet electrospun from a fluid stock described herein). Exemplary methods of gas-assisted electrospinning are described in PCT Patent Application PCT/US2011/024894 (“Electrospinning apparatus and nanofibers produced therefrom”), which is incorporated herein for such disclosure. In gas-assisted embodiments, the gas is optionally air or any other suitable gas (such as an inert gas, oxidizing gas, or reducing gas). In some embodiments, gas assistance increases the throughput of the process and/or reduces the diameter of the nanofibers. In some instances, gas assisted electrospinning accelerates and elongates the jet of fluid stock emanating from the electrospinner. In some embodiments, incorporating a gas stream inside a fluid stock produces hollow nanofibers. In some embodiments, the fluid stock is electrospun using any method known to those skilled in the art.

In specific embodiments, the process comprises coaxial electrospinning (electrospinning two or more fluids about a common axis). As described herein, coaxial electrospinning a first fluid stock as described herein (i.e., comprising a metal reagent component and a polymer) with a second fluid is used to add coatings, make hollow nanofibers, make nanofibers comprising more than one material, and the like. In various embodiments, the second fluid is either outside (i.e., at least partially surrounding) or inside (e.g., at least partially surrounded by) the first fluid stock. In some embodiments, the second fluid is a gas (gas-assisted electrospinning). In some embodiments, gas assistance increases the throughput of the process, reduces the diameter of the nanofibers, and/or is used to produce hollow nanofibers. In some embodiments, the method for producing nanofibers comprises coaxially electrospinning the first fluid stock and a gas. In other embodiments, the second fluid is a second fluid stock having the characteristics as described herein (i.e., comprising a polymer and metal reagent component according to the instant disclosure).

In some embodiments, electrospinning is achieved by electrospinning a fluid stock through a nozzle apparatus, the nozzle apparatus having an inner needle and an outer needle (e.g., wherein the inner and outer needles are arranged concentrically or along a common axis). In some embodiments, the fluid stock is electrospun through the inner needle, while the outer needle provides a gas, e.g., so as to provide gas assistance to the electrospinning process. In some embodiments, the inner needle has any suitable inner diameter, such as 0.05 to 1 mm (and, e.g., an outer diameter of 0.2 to 1.5 mm), and the outer needle having any suitable inner diameter (which is greater than the outer diameter of the inner needle), such as 0.7 to 2 mm. The gas applied to, or provided by, the outer needle has any suitable velocity, such as 200 m/s to 500 m/s. The flow rate of any fluid stock provided herein (e.g., to the inner needle) is any suitable rate (e.g., the rate may be much higher with common axial gas assistance than would otherwise be possible) 1×10⁻¹¹ to 1×10⁻⁹ m/s. Any suitable charge is applied to the nozzle apparatus (e.g., to the inner needle) and/or the collector. For example, a change of +5 kV to +30 kV (e.g., about +20 kV) is optionally applied to the collector. Further, any suitable distance between the nozzle apparatus and the collector is optionally utilized (e.g., 5-25 cm, about 10 cm, or the like).

### Nanofibers

In certain embodiments, provided herein are nanofibers having improved performance and/or characteristics. In some embodiments, such improvements are achieved via use of the aligned nanofiber layering processes described herein. In certain embodiments, provided herein are nanofibers and processes for producing nanofibers (e.g., treated nanofibers, such as the third and fourth nanofibers described herein) and nanofiber mats wherein the nanofibers have low levels of wrinkling or curling (e.g., relative to nanofibers prepared in an isotropic, but otherwise similar manner—i.e., without the aligned layering). In some embodiments, less than 50%, less than 40%, less than 30%, less than 20%, less than 10%, or the like of the nanofibers (e.g., of a nanofiber mat) have wrinkling or curling of the nanofibers (e.g., of the wrinkling or curling of the nanofiber ends). In certain embodiments, provided herein are nanofibers and processes for producing nanofibers (e.g., treated nanofibers, such as the third and fourth nanofibers described herein) and nanofiber mats wherein the nanofibers have good length (e.g., relative to nanofibers prepared in an isotropic, but otherwise similar manner—i.e., without the aligned layering). FIG. 7 illustrates the improved nanofiber length of nanofibers prepared in a layered, ordered nanofiber mat, as opposed to nanofibers in isotropic mats prepared according to otherwise similar processes. In some instances, the average length of the treated nanofibers (e.g., the third or fourth nanofibers) are at least 50%, at least 60%, at least 70%, at least 80%, at least 90%, or the like of the pre-treated nanofibers (e.g., the first and/or second nanofibers, respectively). In specific embodiments, the average length of the treated nanofibers is at least 500 microns, at least 750 microns, at least 1 mm, at least 2 mm, or the like. In some embodiments, the average diameter of the treated nanofibers (e.g., the first and/or second nanofibers) is at least 10% less, at least 20% less, at least 25% less, at least 30% less, at least 40% less, or at least 50% less than the diameter of the pre-treated nanofibers (e.g., the third and/or fourth nanofibers, respectively). FIG. 8 illustrates the reduced radial volume of the layered, ordered nanofiber mats for various metal and metal oxide nanofibers compared to isotropic nanofiber mats prepared according to an otherwise similar process.

In some instances nanofibers or plurality of nanofibers, such as a nanofiber mat, (e.g., treated nanofibers) provided herein comprise, on average, at least 20% by weight of the at least one metal component. In more specific embodiments, the metal component constitutes, on average, at least 33% of the nanofiber(s). In still more specific embodiments, the metal component constitutes, on average, at least 50% of the nanofiber(s). In yet more specific embodiments, the metal and component constitutes, on average, at least 70% of the nanofiber(s). In more specific embodiments, the metal component constitutes, on average, at least 90% of the nanofiber(s). In various embodiments, the metal component constitutes, on average, at least 10%, at least 25%, at least 40%, at least 60%, at least 75%, at least 80%, at least 95%, at least 97%, at least 98%, or at least 99% of the nanofiber(s).

In some instances nanofibers or plurality of nanofibers, such as a nanofiber mat, (e.g., treated nanofibers) provided herein comprise, on average, at least 20 elemental wt. % metal. In more specific embodiments, metal constitutes, on average, at least 33 elemental wt. % of the nanofiber(s). In still more specific embodiments, metal constitutes, on average, at least 50 elemental wt. % of the nanofiber(s). In yet more specific embodiments, metal constitutes, on average, at least 70 elemental wt. % of the nanofiber(s). In more specific embodiments, metal constitutes, on average, at least 90 elemental wt. % of the nanofiber(s). In various embodiments, metal constitutes, on average, at least 10 elemental wt. %, at least 25 elemental wt. %, at least 40 elemental wt. %, at least 60 elemental wt. %, at least 75 elemental wt. %, at least 80 elemental wt. %, at least 95 elemental wt. %, at least 97 elemental wt. %, at least 98 elemental wt. %, or at least 99 elemental wt. % of the nanofiber(s).

In some embodiments, provided herein are high quality nanofibers, nanofiber mats, and processes for preparing high quality nanostructure additives that have good structural integrity, few voids (e.g., having a region so narrow as to cause the nanofibers to be so narrow as to be brittle or have low conductivity, or having regions missing so as to have a discontinuous structure), few structural defects (e.g., amorphous regions an otherwise crystalline nanostructure, crystalline regions in an otherwise amorphous nanostructure, or the like), tunable length, and the like. In some instances, voids or structural defects lead to decreased performance of the nanofibers. For example, in some instances, voids or structural defects cause the nanofibers to have decreased strength, fracture toughness, conductivity, or the like. In one example, voids and defects in the nanofiber include breaks in the nanofiber, regions of nanofiber wherein the diameter is so narrow as to be easily broken (e.g., having a diameter of less than 10% or less than 5% of the average nanofiber diameter), regions of the nanofiber wherein the nanofiber material has anomalous morphologies (e.g., crystalline domains in a substantially amorphous nanofiber—such crystalline domains may increase fracturing and brittleness of the nanofiber), and the like. In some embodiments, there are about 1, about 5, about 10, about 50, about 100, and the like defects per linear mm of nanofiber. In some embodiments, there are at most about 1, at most about 5, at most about 10, at most about 50, at most about 100, and the like defects per linear mm of nanofiber. In other embodiments, the nanofibers have fewer defects and/or voids, wherein the number of defects and/or voids in the nanofiber is in comparison to a nanofiber not produced by the methods of the disclosure (for example with a low loading of precursor). In certain embodiments, use of layered nanofiber deposition techniques as described herein (e.g., along with high loading of precursor relative to polymer loading in the fluid stock/deposited nanofibers) facilitates and/or provides such high quality nanofibers (i.e., treated nanofibers, such as third and/or fourth nanofibers as described herein).

Provided in various embodiments herein are nanofibers (i.e., treated nanofibers) comprising high metal and carbon content (e.g., carbonaceous nanofibers comprising a carbon matrix and domains of metal or metal carbide nanofibers). In some embodiments, such nanofibers comprise at least 99%, at least 98%, at least 97%, at least 96%, at least 95%, at least 90%, at least 80%, or the like of metal and carbon, when taken together, by mass (e.g., elemental mass). In some embodiments, such nanofibers comprise at least 50%, at least 60%, at least 70%, or at least 75% metal by mass (e.g., elemental mass).

In some embodiments, nanofibers (i.e., treated nanofibers) provided herein comprise less than 5% oxygen by mass. In certain embodiments, such nanofibers comprise less than 3% oxygen by mass. In specific embodiments, such nanofibers comprise less than 2% oxygen by mass. In more specific embodiments, these nanofibers comprise less than 1% oxygen by mass. In still more specific embodiments, such nanofibers comprise less than 0.5% oxygen by mass.

Provided in certain embodiments herein are nanofibers (i.e., treated nanofiber) comprising high metal, oxygen and optionally carbon content (e.g., carbonaceous nanofibers comprising a carbon matrix and domains of metal oxide). In some embodiments, such nanofibers comprise at least 99%, at least 98%, at least 97%, at least 96%, at least 95%, at least 90%, at least 80%, or the like of metal, oxygen and carbon, when taken together, by mass (e.g., elemental mass). In more specific embodiments, these nanofibers comprise at least 99%, at least 98%, at least 97%, at least 96%, at least 95%, at least 90%, at least 80%, or the like of metal and oxygen, when taken together, by mass (e.g., elemental mass). In some embodiments, nanofibers provided herein comprise at least 20%, at least 30%, at least 40%, or at least 50% metal by mass (e.g., elemental mass). In some embodiments, nanofibers provided herein comprise at least 50%, at least 60%, at least 70%, or at least 75% metal oxide by mass (e.g., elemental mass).

In some embodiments, nanofibers (i.e., treated nanofiber) provided herein comprise a continuous matrix of a metal component described herein (e.g., metal, metal oxide, ceramic, metal carbide, or the like). In some specific embodiments, the continuous matrix is a continuous crystalline matrix. In other specific embodiments, the continuous matrix is a continuous amorphous matrix. In some embodiments, a continuous matrix of a nanostructure described herein is continuous along a substantial portion of the nanostructure (e.g., along the length—longest dimension—of the nanostructure). In some embodiments, the continuous matrix is found along at least 50%, at least 60%, at least 70%, at least 80%, at least 90%, at least 95%, at least 98%, or at least 99% the length of the nanostructure (e.g., on average for a plurality of nanostructures). In some instances, the continuous matrix runs along at least 50% the length of the nanostructure (e.g., on average for populations of nanofibers). In specific instances, the continuous matrix runs along at least 70% the length (e.g., on average) of the nanostructure(s). In more specific instances, the continuous matrix runs along at least 80% the length (e.g., on average) of the nanostructure (s). In still more specific embodiments, the continuous matrix runs along at least 90% of the length (e.g., on average) of the nanostructure (s). In yet more specific embodiments, the continuous matrix runs along at least 95% of the length (e.g., on average) of the nanostructure (s).

Metal Component

Provided herein are nanofibers (e.g., treated nanofibers, such as of third and/or fourth nanofibers) and processes of preparing such nanofibers, wherein the nanofibers comprise at least one metal component. In some embodiments, the at least one metal component comprises a single metal component. In other embodiments, the at least one metal component(s) comprise two or more metal components (e.g., a composite material). In addition, in some embodiments, each metal component independently comprises one or more metal type (e.g., an example of a metal component comprising two or more metal types is a metal-metal alloy) (a “metal type” may be a specific metal in a zero oxidation state and/or an oxidation state greater than zero). Thus, in some instances, provided herein are metal components comprising a single metal type, but in further or other embodiments, provided herein are metal components comprising two or more metal type. In some instances, a nanofiber comprises at least two metal components, e.g., one of which comprises a single metal type, and a second comprises two or more metal types.

In certain embodiments, a nanofiber (e.g., treated nanofiber) provided herein comprises at least one metal component. In various embodiments, the at least one metal component comprises metal material comprising a single metal with an oxidation state of zero (e.g., Ag, Cu, Ni, Fe, Co, Pb, Au, Sn, Al, Zr, Li, Mn, Cr, Be, Cd, Si, Ti, V, Hf, Sr, Ba, Ge, etc.), or a single metal with an oxidation state of greater than zero (e.g., a metal oxide, such as titania or zirconia; a metal carbide, such as iron carbide, silicon carbide, titanium carbide; or the like). In other embodiments, the at least one metal component comprises metal material comprising at least two metals with an oxidation state of zero (e.g., Ag, Cu, Ni, Fe, Co, Pb, Au, Sn, Al, Zr, Li, Mn, Cr, Be, Cd, Si, Ti, V, Hf, Sr, Ba, Ge, etc.), or at least two metals with an oxidation state of greater than zero (e.g., khamrabaevite—(Ti,V,Fe)C). In some instances, such metal components comprising at least two metals are alloys. Exemplary metal components comprising two or more components (e.g., two or more metals) include, by way of non-limiting example, CdSe, CdTe, PbSe, PbTe, FeNi (perm alloy), Fe—Pt intermetallic compound, stainless steel, Pt—Pb, Pt—Pd, Pt—Bi, Pd—Cu, and Pd—Hf. In other embodiments, the at least one metal component comprises metal material comprising at least one metal with an oxidation state of zero (e.g., Ag, Cu, Ni, Fe, Co, Pb, Au, Sn, Al, Zr, Li, Mn, Cr, Be, Cd, Si, Ti, V, Hf, Sr, Ba, Ge, etc.), and at least one metal with an oxidation state of greater than zero.

In some embodiments, the metal component is or comprises at least one metalloid component. In various embodiments, the at least one metal component comprises metalloid material comprising a single metal with an oxidation state of zero (e.g. Si), or a single metalloid with an oxidation state of greater than zero (e.g., SiO₂, SiC). In other embodiments, the at least one metal component comprises metal material comprising at least two metalloids with an oxidation state of zero, or at least two metalloids with an oxidation state of greater than zero.

In some embodiments, a nanofiber (e.g., treated nanofiber) comprises at least one metal component. In yet other embodiments, the at least one metal component comprises metal material comprising at least one metal with an oxidation state of zero (e.g., Ag, Cu, Ni, Fe, Co, Pb, Au, Sn, Al, Zr, Li, Mn, Cr, Be, Cd, Si, Ti, V, Hf, Sr, Ba, Ge, etc.), and at least one metal with an oxidation state of greater than zero (e.g., a metal oxide, a metal carbide, or the like).

In various embodiments, a metal component (or metal reagent component) provided herein comprises any suitable metal (e.g., in a zero or greater than zero oxidation state), including a transition metal, alkali metal, alkaline earth metal, post-transition metal, lanthanide, or actinide. In certain embodiments, the metal is a transition metal. In some embodiments, the metal is a period IV transition metal. In certain embodiments, the metal is a period V transition metal. In some embodiments, the metal is a group XIII metal. In certain embodiments, the metal is a group XIV metal. In various embodiments, transition metals include: scandium (Sc), titanium (Ti), vanadium (V), chromium (Cr), manganese (Mn), iron (Fe), cobalt (Co), nickel (Ni), copper (Cu), zinc (Zn), yttrium (Y), zirconium (Zr), niobium (Nb), molybdenum (Mo), technetium (Tc), ruthenium (Ru), rhodium (Rh), palladium (Pd), silver (Ag), cadmium (Cd), hafnium (Hf), tantalum (Ta), tungsten (W), rhenium (Re), osmium (Os), iridium (Ir), platinum (Pt), gold (Au), mercury (Hg), rutherfordium (Rf), dubnium (Db), seaborgium (Sg), bohrium (Bh), and hasium (Hs). Suitable alkali metals include: lithium (Li), sodium (Na), potassium (K), rubidium (Rb), cesium (Cs) and francium (Fr). Suitable alkaline earth metals include: beryllium (Be), magnesium (Mg), calcium (Ca), strontium (Sr), barium (Ba), and radium (Ra). Suitable post-transition metals include: aluminum (Al), gallium (Ga), indium (In), tin (Sn), thallium (Tl), lead (Pb), and bismuth (Bi). Suitable lanthanides include the elements with atomic number 57 to 71 on the periodic table. Suitable actinides include the elements with atomic number 89 to 103 on the periodic table. In some embodiments, the metal is a metalloid, such as, germanium (Ge), antimony (Sb) and polonium (Po), or silicon (Si). It is to be understood that metal components described herein are intended to include metalloid components. In some embodiments, the metal component is not an oxide of silicon (e.g., SiO₂ or SiTiO₃). In other embodiments, the metal component is not an oxide of titanium (e.g., TiO₂ or SiTiO₄). In yet other embodiments, the metal component is not a ceramic.

Such metals are optionally present in the metal component(s) of the nanostructure in an oxidation state of zero (generally referred to herein as a “elemental metal” or “elemental metalloid”), greater than zero, or a combination thereof. Oxidations states of greater than zero include metal oxides, metal carbides, and the like. In specific embodiments, the metal component of a nanostructure provided herein comprises a metal oxide. In more specific embodiments, the metal oxide is a ceramic, such as alumina, silica, titania, zirconia, or the like. In some embodiments, the metal oxide is an oxide of Al, Zr, Fe, Cu, Ni, Zn, Cd, Si, Ti, V, Sn, Co, Hf, Ba, Sr, or a combination thereof. Exemplary metal components comprising a metal oxide include, by way of non-limiting example, Al₂O₃, ZrO₂, Fe₂O₃, CuO, NiO, ZnO, CdO, SiO₂, TiO₂, V₂O₅, VO₂, Fe₃O₄, SnO, SnO₂, CoO, CoO₂, Co₃O₄, HfO₂, BaTiO₃, SrTiO₃, Ba_{0.55}Sr_{0.45}TiO₃, and the like.

In some embodiments, the metal components is a material of formula (I):

MₓL_{y} (I)

wherein M is one or more metal (e.g., having an oxidation tate of zero or greater than zero) and L is one or more of B, C, N, O, P, S, and/or Se, x is an integer of greater than 0, and y is an integer (e.g., y may be zero if the oxidation state of all metals M are zero).

In certain embodiments, the metal component is a material of formula (Ia)

M¹ₐM²_{b}M³_{c}M⁴_{d}L¹_{g}L²ₕ (Ia)

wherein each of M¹, M², M³, and M⁴ is independently selected from a metal, and each of L¹ and L² is independently selected from B, C, N, O, P, S, or Se, each of a, b, c, and d are independently selected from 0-25, the sum of a, b, c, and d is an integer greater than 0, each of g and h is independently selected from 0-10, an the sum of g and h is an integer 0-20. In specific embodiments, g and h are 0. In some embodiments, L¹ is O and h is 0. In some embodiments, L¹ is B, C, or S, and h is 0. In specific embodiments, each of M¹, M², M³, and M⁴ are independently selected from Fe, Ti, Si, Ag, Cu, Ni, Co, Au, Al, Zr, Li, Cr, Mg, Ca, Hf, Mn, Ru, Rh, Zn, Cd, Sn, Ge. In more specific embodiments, each of M¹, M², M³, and M⁴ are independently selected from Fe, Ti, Ag, Cu, Ni, Co, Au, Zr, Li, Mg, Ca, Hf, Mn, Ru, Rh, Zn, Cd, Sn, Ge.

Treated Nanofiber Nanocomposites

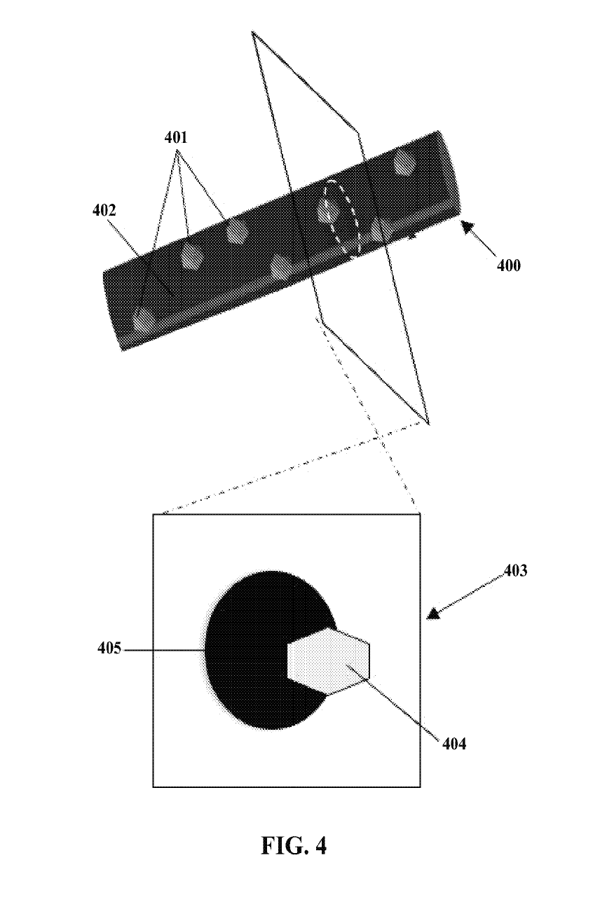

In some embodiments, nanofibers (e.g., treated nanofibers) provided herein are nanocomposite nanofibers. In certain embodiments, a nanocomposite nanofiber comprises at least two different components, at least one of which is a metal component as described herein. In some embodiments, a second component is a second metal component. Such nanocomposite nanostructures may also be described as composite nanofibers or hybrid nanofibers. FIG. 4 illustrates an exemplary nanostructure nanocomposite 400 comprising (i) discrete domains of metal component 901, and (ii) a continuous matrix material 402 (which may comprise a second metal component or another material, such as amorphous carbon). As illustrated in the cross-sectional view 403, the discrete domains of metal component 404 may penetrate into the core 405 of the nanofiber. In some instances, the nanofibers comprise metal component on the surface of the nanofibers. And in some instances, the nanofibers comprise or further comprise discrete domains of metal component completely embedded within the core matrix material.

In some embodiments, nanocomposite nanofibers (e.g., treated nanofibers) comprise (i) a continuous matrix material comprising a first component, and (ii) a plurality of isolated domains comprising a second component. In some embodiments, the continuous matrix is crystalline or amorphous. In certain embodiments, the isolated domains comprise nanoparticles (e.g., comprising a metal component). In specific embodiments, the first (continuous matrix) component is any metal component described herein. In others, it is not. In some embodiments, the first (continuous matrix) component is carbon (e.g., amorphous carbon). In specific embodiments, the second component is any metal component described herein. In certain embodiments, a continuous matrix comprises a single material (and, in some instances, a similar morphology) along a significant portion of the nanofiber. For example a continuous matrix within a nanostructure is continuous along at least 50% of the length of the nanostructure (i.e., the longest dimensions of the nanostructure). In more specific embodiments, the continuous matrix runs along at least 70% of the length of the nanostructure. In still more specific embodiments, the continuous matrix runs along at least 80% of the length of the nanofiber. In yet more specific embodiments, the continuous matrix runs along at least 90% of the length of the nanofiber. In specific embodiments, the continuous matrix runs along at least 95% of the length of the nanofiber. In more specific embodiments, the continuous matrix runs along at least 98% of the length of the nanofiber. In yet more specific embodiments, the continuous matrix runs along at least 99% of the length of the nanofiber.

In certain embodiments, nanocomposite nanofibers comprise (i) a core comprising a first material; and (ii) a sheath comprising a second material, wherein the sheath material is layered upon and/or at least partially coats or covers the core material. Additional layers are layered on top of the sheath. Each optional layer may comprise further components, or components similar to those found in the core and/or sheath. In some instances, the nanocomposite nanofiber comprises a core and at least two layers (one of which is the sheath), wherein the core and two layers all comprise different materials. In other embodiments, the nanocomposite nanofiber comprises a core and at least two layers, wherein the core and outer layer are the same material.

In some embodiments, such nanocomposite nanofibers are prepared by electrospinning a first fluid stock and a second fluid stock (and optional additional fluid stock(s)) about a common axis (i.e., co-axial electrospinning) (e.g., as illustrated in FIG. 2). For additional disclosure on common axial electrospinning, see U.S. patent application Ser. No. 13/451,960, which is hereby incorporated herein by reference in its entirety, and, specifically, for such disclosure. In some embodiments, the first layer (core) comprises an elemental or alloy metal. In some embodiments the second layer (sheath) comprises an elemental or alloy metal. In various embodiments, the nanocomposite nanofiber is elemental or alloy metal-on-elemental metal, ceramic-on-elemental or alloy metal, ceramic-on-ceramic, or an elemental or alloy metal-on-ceramic. In some embodiments, the hybrid nanofiber has at least 3 components.

Treated Nanofiber Composition

In certain embodiments, any nanofiber (e.g., treated nanofiber) described herein optionally further comprises one or more additional component (i.e., in addition to the at least one metal component). For example, a nanofiber described herein may optionally comprise a continuous carbon matrix. In some embodiments, other materials may be present, such as organic materials, organic components, reactive compounds, additive, or the like.

In certain embodiments, nanofibers (e.g., a plurality of nanofibers, such as a nanofiber mat) (e.g., treated nanofibers, such as third and/or fourth nanofibers) provided herein comprises, on average, less than 20 wt. % organic material. In specific embodiments, nanofibers provided herein comprise, on average, less than 10 wt. % organic material. In more specific embodiments, a nanofibers provided herein comprise, on average, less than 5 wt. % organic material. In still more specific embodiments, nanofibers provided herein comprise, on average, less than 2 wt. % organic material. In yet more specific embodiments, nanofibers provided herein comprise, on average, less than 1 wt. % organic material. In some embodiments, nanofibers provided herein comprise, on average, less than 50 wt. % organic material, less than 30 wt. % organic material, less than 15 wt. % organic material, less than 3 wt. % organic material, less than 0.5 wt. % organic material, less than 0.1 wt. % organic material.

In certain embodiments, nanofibers (e.g., a plurality of nanofibers(s), such as a nanofiber mat) (e.g., treated nanofibers, such as third and/or fourth nanofibers) provided herein comprises on average less than 20 elemental wt. % carbon. In specific embodiments, nanofibers provided herein comprise, on average, less than 10 elemental wt. % carbon. In more specific embodiments, nanofibers provided herein comprise, on average, less than 5 elemental wt. % carbon. In still more specific embodiments, nanofibers provided herein comprise, on average, less than 2 elemental wt. % carbon. In yet more specific embodiments, nanofibers provided herein comprise, on average, less than 1 elemental wt. % carbon. In some embodiments, nanofibers provided herein comprise, on average, less than 50 elemental wt. % carbon, less than 30 elemental wt. % carbon, less than 15 elemental wt. % carbon, less than 3 elemental wt. % carbon, less than 0.5 elemental wt. % carbon, less than 0.1 elemental wt. % carbon.

Nanofiber Characteristics

In certain embodiments, nanofibers (e.g., deposited or treated nanofibers) have certain dimensions, aspect ratios, specific surface areas, porosities, conductivities, flexibilities, and the like that are beyond what was previously achievable.

In some embodiments, provided herein is a nanofiber or plurality of nanofibers (such as a layered nanofiber mat), wherein the nanofiber(s) are produced by treating deposited nanofibers, which are deposited on a collector after being electrospun from an aqueous fluid stock comprising polymer and metal precursor (e.g., in using a layered processing technique as described herein).

In some embodiments, provided herein are the nanofibers (e.g., treated nanofibers), such as in a nanofiber mat, having an (e.g., mean or median) aspect ratio of more than 20. In specific embodiments, nanofibers provided herein have an (e.g., mean or median) aspect ratio of more than 40. In more specific embodiments, nanofibers provided herein have an (e.g., mean or median) aspect ratio of more than 50. In still more specific embodiments, nanofibers provided herein an (e.g., mean or median) aspect ratio of more than 100. In yet more specific embodiments, nanofibers provided herein have an (e.g., mean or median) aspect ratio of more than 200. In more specific embodiments, nanofibers provided herein an (e.g., mean or median) aspect ratio of more than 400. In more specific embodiments, nanofibers provided herein an (e.g., mean or median) aspect ratio of more than 500. In yet more specific embodiments, nanofibers provided herein an (e.g., mean or median) aspect ratio of more than 1000. The nanofibers have any suitable aspect ratio (length/diameter). In some embodiments, the nanofibers have an (e.g., mean or median) aspect ratio of about 10, about 10², about 10³, about 10⁴, about 10⁵, about 10⁶, about 10⁷, about 10⁸, about 10⁹, about 10¹⁰, about 10¹¹, about 10¹², and the like. In some embodiments the nanofibers have an (e.g., mean or median) aspect ratio of at least 10, at least 10², at least 10³, at least 10⁴, at least 10⁵, at least 10⁶, at least 10⁷, at least 10⁸, at least 10⁹, at least at least 10¹¹, at least 10¹², and the like.

Nanofibers (e.g., treated nanofibers) provided herein may have any suitable diameter (e.g., as determined by SEM, TEM, or any other suitable method) (e.g., the most narrow, or most narrow non-defect, dimension of the nanofiber). In some embodiments, nanofibers provided herein have (e.g., on average) a diameter of about 20 nm, about 30 nm, about 40 nm, about 50 nm, about 60 nm, about 70 nm, about 80 nm, about 90 nm, about 100 nm, about 130 nm, about 150 nm, about 200 nm, about 250 nm, about 300 nm, about 400 nm, about 500 nm, about 600 nm, about 700 nm, about 800 nm, about 900 nm, about 1,000 nm, about 1,500 nm, about 2,000 nm and the like. In some embodiments, nanofibers provided herein have (e.g., on average) a diameter of at most 20 nm, at most 30 nm, at most 40 nm, at most 50 nm, at most 60 nm, at most 70 nm, at most 80 nm, at most 90 nm, at most 100 nm, at most 130 nm, at most 150 nm, at most 200 nm, at most 250 nm, at most 300 nm, at most 400 nm, at most 500 nm, at most 600 nm, at most 700 nm, at most 800 nm, at most 900 nm, at most 1,000 nm, at most 1,500 nm, at most 2,000 nm and the like. In certain embodiments, nanofibers provided herein have (e.g., on average) a diameter of between about 50 nm and about 300 nm, between about 50 nm and about 150 nm, between about 100 nm and about 400 nm, between about 100 nm and about 200 nm, between about 500 nm and about 800 nm, between about 60 nm and about 900 nm, and the like. In specific embodiments, nanofibers provided herein have (e.g., on average) a diameter of less than 500 nm. In more specific embodiments, nanofibers provided herein have (e.g., on average) a diameter of less than 250 nm. In specific embodiments, treated nanofibers provided herein have a (e.g., average) diameter of 50 nm to 1000 nm, or 50 nm to 800 nm. In some embodiments, treated nanofibers provided herein have a (e.g., average) diameter of 500 nm or less. In some embodiments, treated nanofibers provided herein have a (e.g., average) diameter of 400 nm or less. In some embodiments, treated nanofibers provided herein have a (e.g., average) diameter of 200 nm to 500 nm. In other specific embodiments, deposited nanofibers described herein have a (e.g., average) diameter of less than 2000 nm. In more specific embodiments, deposited nanofibers described herein have a (e.g., average) diameter of 100 nm to 1500 nm, or 100 nm to 1000 nm.

The nanofibers (e.g., treated nanofibers) have any suitable length (e.g., as determined by microscopy, such as SEM or TEM, or any other suitable technique). In some instances, a given plurality of nanofibers comprise nanofibers that have a distribution of structures of various lengths. In some embodiments, certain structures of a population exceed or fall short of the average length. In some embodiments, nanofibers provided herein have an average length of about 20 μm, about 50 μm, about 100 μm, about 500 μm, about 1,000 μm, about 5,000 μm, about 10,000 μm, about 50,000 μm, about 100,000 μm, about 500,000 μm, and the like. In some embodiments, the nanofiber has an average length of at least about 20 μm, at least about 50 μm, at least about 100 μm, at least about 500 μm, at least about 1,000 μm, at least about 5,000 μm, at least about 10,000 μm, at least about 50,000 μm, at least about 100,000 μm, at least about 500,000 μm, and the like. In specific embodiments, provided herein are nanofibers (e.g., treated nanofibers) comprising crystalline metal component (e.g., a zero oxidation state metal, or a greater than zero oxidation state metal, such as metal oxide, metal carbide, or the like), such as a continuous matrix of crystalline metal component, and having a length of at least 750 microns, at least 1 mm, at least 1.25 mm, at least 1.5 mm, at least 2 mm, at least 3 mm, at least 5 mm, or the like. As illustrated in FIG. 7, processes described herein are suitable for preparing nanofibers comprising crystalline metal component and having improved length over isotropic electrospinning techniques (i.e., non-layered and unaligned approaches).

The nanofibers (e.g., treated nanofibers) provided herein have any suitable specific surface area (surface area divided by mass (or volume)). In some embodiments, the specific surface area of nanofibers provided herein is at least 0.1 m²/g, at least 1 m²/g, at least 5 m²/g, at least 10 m²/g, at least 50 m²/g, at least 100 m²/g, at least 200 m²/g, at least 500 m²/g, at least 1,000 m²/g, at least 1,500 m²/g, at least 2,000 m²/g, or the like.

The nanofibers (e.g., treated nanofibers) provided herein have any suitable porosity. In some embodiments, the porosity is about 1%, about 2%, about 4%, about 6%, about 8%, about 10%, about 15%, about 20%, about 25%, about 30%, about 40%, about 50%, about 60%, about 70% and the like. In some embodiments, the porosity is at most 1%, at most 2%, at most 4%, at most 6%, at most 8%, at most 10%, at most 15%, at most 20%, at most 25%, at most 30%, at most 40%, at most 50%, at most 60%, at most 70% and the like. In some embodiments, the porosity is at least 1%, at least 2%, at least 4%, at least 6%, at least 8%, at least 10%, at least 15%, at least 20%, at least 25%, at least 30%, at least 40%, at least 50%, at least 60%, at least 70% and the like. In some embodiments, the porosity is between about 1% and 10%, between about 10% and 50%, between about 20% and 30%, between about 30% and 70%, between about 1% and 50%, between about 5% and 20%, and the like. In certain instances, porosity is the void amount of the nanofiber divided by the theoretical volume of the nanofiber. In specific instances, porosity is determined by measuring the volume displacement caused by the nanofiber in a fluid and comparing it the theoretical volume of the nanofiber (e.g., π·radius²·length).

Methods for measuring the diameter, aspect ratio, or other dimensional characteristic of a nanofiber described herein may include any suitable method. Such methods include, but are not limited to microscopy, optionally transmission electron microscopy (“TEM”) or scanning electron microscopy (“SEM”). Surface area may be calculated by measuring the diameter and length of nanofiber in the sample and applying the equation for the surface area of a cylinder (i.e., 2 times pi times half of the diameter of the nanofiber times the sum of the length of the nanofiber and half of the diameter of the nanofiber). Surface area may also be measured by physical or chemical methods, for example by the Brunauer-Emmett, and Teller (BET) method where the difference between physisorption and desorption of inert gas is utilized.

Nanofiber and Nanofiber Mat Properties

In some embodiments, nanofibers (e.g., nanofiber mats) provided herein have (an average) electrical conductivity of at least 5%, at least 10%, at least 20%, at least 30%, at least 40%, at least 50%, at least 60%, at least 70%, at least 80%, at least 90%, at least 95%, at least 99%, at least 100% when compared with the conductivity of the bulk material (e.g., when formed into a sheet) (e.g., over a distance of at least 1 cm, at least 2 cm, at least 3 cm, at least 4 cm, at least 5 cm, or the like). In some embodiments, the conductivity is at least 1 S/cm, at least 10 S/cm, at least 100 S/cm, at least 10³ S/cm, at least 10⁴ S/cm, at least 10⁵ S/cm, at least 10⁶ S/cm, at least 10⁷ S/cm, at least 10⁸ S/cm, and the like. In some embodiments, the conductivity is between about 1 S/cm and 10 S/cm, between about 10 S/cm and 100 S/cm, between about 100 S/cm and 1,000 S/cm, between about 1,000 S/cm and 10⁴ S/cm, between about 10⁴ S/cm and 10⁵ S/cm, between about 10⁵ S/cm and 10⁶ S/cm, between about 10⁶ S/cm and 10⁷ S/cm, between about 10⁷ S/cm and 10⁸ S/cm, between about 10⁵ S/cm and 10⁸ S/cm, and the like. In some embodiments, layered and ordered nanofiber mats provided herein have a conductivity that its at least 5% greater, at least 10% greater, at least 20% greater, at least 25% greater, or the like than isotropic nanofiber mats of the same type (e.g., over a distance of at least 1 cm, at least 2 cm, at least 3 cm, at least 4 cm, at least 5 cm, or the like). FIG. 9 illustrates the improved electrical conductivity of layered and ordered nanofiber mats for various metal oxides compared to the electrical conductivity of isotropic nanofiber mats of the same metal oxides.

In some embodiments, the nanofibers of the present disclosure are flexible. In some instances, flexible nanofibers are advantageous in certain applications. In some instances, flexibility is quantified by the Young's modulus, which is the slope of the initial linear portion of a stress-strain curve. The Young's modulus has units of pressure, such as mega Pascals (MPa). In some embodiments, flexibility is different along different directions of the material, so may be reported with respect to a certain direction, or is reported as an average value. The nanostructures have any suitable flexibility. In some embodiments, the nanostructures has a Young's modulus of at least 10 MPa, at least 100 MPa, at least 250 MPa, at least 500 MPa, at least 1,000 MPa, at least 4,000 MPa, at least 6,000 MPa, at least 8,000 MPa, or the like.

In certain embodiments, provided herein are nanofibers comprising one or more zero oxidation state metal (a metal described herein, generally refers to a zero oxidation state metal, unless otherwise stated). In specific embodiments, the nanostructures comprise a single zero oxidation state metal. In general, the metal may be any suitable metal, such as one of those described herein. In some embodiments, the metal (i.e., zero oxidation state metal) is Fe, Ti, Si, Ag, Cu, Ni, Co, Au, Al, Zr, Hf, Mn, Ru, Rh, Zn, Cd, Sn, or Ge. In specific embodiments, the nanostructures comprise zero oxidation state metal. In more specific embodiments, the one or more zero oxidation state metal is nickel (Ni). In other embodiments, the one or more zero oxidation state metal is copper (Cu). In still other embodiments, the one or more zero oxidation state metal is silver (Ag). In yet other embodiments, the one or more zero oxidation state metal is iron (Fe). In still other embodiments, the one or more zero oxidation state metal is lead (Pb). In yet other embodiments, the one or more zero oxidation state metal is cobalt (Co). In other embodiments, the nanostructures comprise zero oxidation state metalloid. In specific embodiments, the zero oxidation state metalloid is silicon.

In some embodiments, the one or more zero oxidation state metal is a metal alloy. In specific embodiments, the metal alloy is a carbon alloy, a selenium alloy, a metal-metal alloy, a metal-metal oxide alloy, a tellurium alloy, or the like. In general, the alloy may comprise any suitable metal, in combination with a second component, such as carbon, selenium, tellurium, a non-metal, additional metal(s), metal oxides, or any other suitable component. In specific embodiments, the metal alloy comprises Fe, Ti, Si, Ag, Cu, Ni, Co, Au, Al, Zr, Li, Mg, Ca, Hf, Mn, Ru, Rh, Zn, Cd, Sn, Ge, or any combination thereof.

Such structures may have any of the performance characteristics described herein. Exemplary performance characteristics of metal nanofibers described herein are described throughout this disclosure and below.

In certain embodiments, the nanofibers comprise (e.g., on average) at least 50 wt. % zero oxidation state metal. In specific embodiments, the nanofibers comprise (e.g., on average) at least 60 wt. % zero oxidation state metal. In more specific embodiments, the nanofibers comprise (e.g., on average) at least 75 wt. % zero oxidation state metal. In still more specific embodiments, the nanofibers comprise (e.g., on average) at least 90 wt. % zero oxidation state metal. In yet more specific embodiments, the nanofibers comprise (e.g., on average) at least 95 wt. % zero oxidation state metal. In specific embodiments, the nanofibers comprise (e.g., on average) at least 98 wt. % zero oxidation state metal. In more specific embodiments, the nanofibers comprise (e.g., on average) at least 99 wt. % zero oxidation state metal.

In certain embodiments, the nanofibers comprise (e.g., on average) least 50 elemental wt. % metal, when taken together. In more specific embodiments, metal constitutes, on average, at least 60 elemental wt. % of the nanofiber(s). In still more specific embodiments, metal constitutes, on average, at least 75 elemental wt. % of the nanofiber(s). In yet more specific embodiments, metal constitutes, on average, at least 80 elemental wt. % of the nanofiber(s). In more specific embodiments, metal constitutes, on average, at least 90 elemental wt. % of the nanofiber(s). In various embodiments, metal constitutes, on average, at least 40 elemental wt. %, at least 70 elemental wt. %, at least 85 elemental wt. %, at least 95 elemental wt. %, at least 97 elemental wt. %, at least 98 elemental wt. %, or at least 99 elemental wt. % of the nanofiber(s).

In some embodiments, nanofibers provided herein have (an average) electrical conductivity of at least 50%, at least 60%, at least 70%, at least 80%, at least 90%, at least 95%, at least 99%, or at least 100% when compared with the conductivity of the bulk material (e.g., when formed into a sheet).

In certain embodiments, provided herein are nanofibers comprising one or more metal having an oxidation state of greater than zero. In specific embodiments, the nanofibers comprise a single metal component having an oxidation state of greater than zero. In specific embodiments, the metal component is a metal oxide (e.g., a ceramic). In general, the metal oxide may be an oxide of any suitable metal(s), metalloid(s), or combination thereof. Exemplary metals include those described herein. In some embodiments, the metal oxide is an oxide of Fe, Ti, Si, Ag, Cu, Ni, Co, Au, Al, Zr, Hf, Mn, Ru, Rh, Zn, Cd, Sn, Ge, or a combination thereof. In specific embodiments, the nanostructures comprise an oxidized metal. In more specific embodiments, the oxidized metal is an oxide of nickel (Ni). In other embodiments, the oxidized metal is an oxide of copper (Cu). In still other embodiments, the oxidized metal is an oxide of zinc (Zn). In yet other embodiments, the oxidized metal is an oxide of zirconium (Zr). In still other embodiments, the oxidized metal is an oxide of titanium (Ti). In yet other embodiments, the oxidized metal is an oxide of cobalt (Co). In yet other embodiments, the one or more zero oxidation state metal is barium (Ba). In specific embodiments, the oxidized metalloid is an oxide of silicon (e.g., silica). In some embodiments, nanofibers described herein optionally comprises one or more metal having an oxidation state of greater than zero and one or more metal having an oxidation state of zero.

Such nanofibers may have any of the performance characteristics described herein. Exemplary performance characteristics of metal oxide (e.g., ceramic) nanostructures described herein are described throughout this disclosure and below.

In certain embodiments, the metal oxide (e.g., ceramic) is in an amorphous state. In specific embodiments, nanofibers provided herein comprise a continuous matrix of amporphous metal oxide (e.g., ceramic). For example a continuous matrix within a nanofiber is continuous along at least 50% of the length of the nanofiber (i.e., the longest dimensions of the nanofiber). In more specific embodiments, the continuous matrix runs along at least 70% of the length of the nanofiber. In still more specific embodiments, the continuous matrix runs along at least 80% of the length of the nanofiber. In yet more specific embodiments, the continuous matrix runs along at least 90% of the length of the nanofiber. In specific embodiments, the continuous matrix runs along at least 95% of the length of the nanofiber. In more specific embodiments, the continuous matrix runs along at least 98% of the length of the nanofiber. In yet more specific embodiments, the continuous matrix runs along at least 99% of the length of the nanofiber. In some embodiments, such continuous matrix dimensions are the average of a plurality of nanofibers, such as in a nanofiber mat.

In certain embodiments, the nanofibers comprise (e.g., on average) at least 50 wt. % metal oxide. In specific embodiments, the nanofibers comprise (e.g., on average) at least 60 wt. % metal oxide. In more specific embodiments, the nanofibers comprise (e.g., on average) at least 75 wt. % metal oxide. In still more specific embodiments, the nanofibers comprise (e.g., on average) at least 90 wt. % metal oxide. In yet more specific embodiments, the nanofibers comprise (e.g., on average) at least 95 wt. % metal oxide. In specific embodiments, the nanofibers comprise (e.g., on average) at least 98 wt. % metal oxide 1. In more specific embodiments, the nanofibers comprise (e.g., on average) at least 99 wt. % metal oxide.

In certain embodiments, the nanofibers comprise (e.g., on average) least 50 elemental wt. % metal. In more specific embodiments, metal constitutes, on average, at least 60 elemental wt. % of the nanofiber(s). In still more specific embodiments, metal constitutes, on average, at least 75 elemental wt. % of the nanofiber(s). In yet more specific embodiments, metal constitutes, on average, at least 80 elemental wt. % of the nanofiber(s). In more specific embodiments, metal constitutes, on average, at least 90 elemental wt. % of the nanofiber(s). In various embodiments, metal constitutes, on average, at least 20 elemental wt. %, at least 30 elemental wt. %, at least 40 elemental wt. %, at least 70 elemental wt. %, at least 85 elemental wt. %, at least 95 elemental wt. %, at least 97 elemental wt. %, at least 98 elemental wt. %, or at least 99 elemental wt. % of the nanofiber(s).

Any characteristics described herein for a nanofiber or nanofibers are intended to include disclosure for the characteristics of a single nanofiber, or for one or more nanofibers, such as in a nanofiber mat. In some instances, description of one or more or a plurality of nanofibers herein includes a plurality of nanofiber segments. For example, in some instances, one or more or a plurality of nanofibers described in a layer herein comprises a single continuous nanofiber, e.g., a first segment of which is positioned in a first direction, a second segment of which turns the nanofiber about 180 degrees (or, e.g., 150-210 degrees) (e.g., as illustrated by 1005 in FIG. 10), a third segment of which is positioned in a second direction that is aligned with the first direction, and so forth (e.g., the single continuous fiber winding back and forth to form an aligned nanofiber layer comprising one or more or a plurality of nanofibers (in this case, nanofiber segments)). FIG. 10 illustrates an aligned nanofiber mat 1001. Nanofibers are aligned because nanofiber segments 1002 are aligned, including aligned portions of a single continuous nanofiber 1003 and aligned individual nanofibers 1004. Either or both such alignment is optionally present when discussing aligned nanofibers and aligned nanofiber mats herein.

### EXAMPLES

### Example 1

### Preparing a Fluid Stock of Nickel Acetate and PVA

Two (2) grams of nickel acetate, the metal precursor, was dissolved in 20 ml of 1 molar acetic acid solution. The solution was stirred for 2 hours to create a solution of nickel acetate. The solution was homogenous.

In a second solution, 1 gram of 99.7% hydrolyzed polyvinyl alcohol (PVA) with an average molecular weight of 79 kDa and polydispersity index of 1.5 was dissolved in 10 ml of de-ionized water. The polymer solution was heated to a temperature of 95° C. and stirred for 2 hours to create a homogenous solution.

The nickel acetate solution was then combined with the PVA solution to create a fluid stock. In order to distribute the precursor substantially evenly in the fluid stock, the precursor solution was added gradually to the polymer solution while being continuously vigorously stirred for 2 hours. The mass ratio of precursor to polymer for the fluid feed (based on initial nickel acetate mass) was 2:1.

### Example 2

### Electrospinning a Fluid Stock of Nickel Acetate and PVA

The fluid stock of Example 1 is electrospun by a gas-assisted technique. The fluid stock is loaded into a syringe pump connected to a spinneret with an inner nozzle diameter (fluid stock) of 4.13×10⁻⁴ m and an outer (air) diameter of 1.194×10⁻³ m. The distance between the nozzle and the collection plate is kept at about 15 cm and the fluid stock is spun at a rate of 0.1 ml/min. A charge of +15 kV is maintained at the collector. The air velocity at the nozzle was 100 m/s. The temperature of the air and fluid stock at the nozzle is 300 K. Nanofibers are collected and aligned between separated copper collectors at a distance of 5 cm with each aligned layer consisting of 0.1 grams of nanofibers.

### Example 3

### Copper Acetate and PVA Fluid Stock and Nanofiber

Following the procedure of Example 1, a fluid stock of copper acetate and PVA is prepared with ratios of precursor:polymer of 2:1. These fluid stocks are electrospun by the procedure of Example 2.

### Example 4

### Silver Acetate and PVA Fluid Stock and Nanofiber

Following the procedure of Example 1, a fluid stock of silver acetate and PVA is prepared with ratios of precursor:polymer of 2:1. These fluid stocks are electrospun by the procedure of Example 2.

### Example 5

### Iron Acetate and PVA Fluid Stock and Nanofiber

Following the procedure of Example 1, a fluid stock of iron acetate and PVA is prepared with ratios of precursor:polymer of 2:1. These fluid stocks are electrospun by the procedure of Example 2.

### Example 6

### Zinc Acetate and PVA Fluid Stock and Nanofiber

Following the procedure of Example 1, a fluid stock of zinc acetate and PVA is prepared with ratios of precursor:polymer of 2:1. These fluid stocks are electrospun by the procedure of Example 2.

### Example 7

### Cadmium Acetate and PVA Fluid Stock and Nanofiber

Following the procedure of Example 1, a fluid stock of cadmium acetate and PVA is prepared with ratios of precursor:polymer of 2:1. These fluid stocks are electrospun by the procedure of Example 2.

### Example 8

### Zirconium Acetate and PVA Fluid Stock and Nanofiber

Following the procedure of Example 1, a fluid stock of zirconium acetate and PVA is prepared with ratios of precursor:polymer of 2:1. These fluid stocks are electrospun by the procedure of Example 2.

### Example 9

### Lead Acetate and PVA Fluid Stock and Nanofiber

Following the procedure of Example 1, a fluid stock of lead acetate and PVA is prepared with ratios of precursor:polymer of 2:1. These fluid stocks are electrospun by the procedure of Example 2.

### Example 10

### Lead Acetate, Selenium Powder and PVA Fluid Stock and Nanofiber

A mixture of 50/50 lead acetate and Se powder is prepared according to the procedures of Example 1. The precursors are further made into a fluid stock with PVA according to the procedure of Example 1 and electrospun according to the procedure of Example 2 to produce nanofibers.

### Example 11

### Fluid Feeds and Nanofibers

Following procedures similar to Example 1, fluid stocks are prepared by combining silicon acetate and PVA, iron acetate and PVA, and titanium dioxide nanoparticles and PVA. These fluid stocks are electrospun according to the procedure of Example 2 to produce nanofibers.

Additionally, following the procedure of Example 1, fluid stocks are prepared according to Table 1 in the identified precursor-to-polymer load ratio (based on initial precursor mass combined with the polymer). These fluid stocks are also electrospun according to the procedure of Example 2.

TABLE 1

| reagent | polymer | load ratio |
|---|---|---|
| iron nitrate | PVA | 1:1 |
| iron chloride (+carbon powder) | PVA | 2:1 |
| iron acetate chromium acetate | PVE | 1:1 |
| | | (89/11) |
| zirconium chloride | PVA | 2:1 |
| nickel bromide | PEO | 1:1 |
| chromium methoxide | PVE | 1.5:1 |
| tungsten ethoxide | PVA | 3:1 |
| CdClOH | polyvinyl pyridine | 1:1 |
| silver acetate | PEO | 1:1 |
| nickel nitrate | polyacrylic acid | 2:1 |
| copper ethoxide | PVA | 1:1 |
| nickel chloride | PVE | 3:1 |
| zirconium nitrate | polyvinyl pyridine | 1:1 |
| copper nitrate | PVE | 3.5:1 |
| nickel t-butoxide | PVO | 1:1 |
| copper chloride | polyacrylic acid | 1.5:1 |
| aluminum nitrate | PVE | 2:1 |
| zirconium acetate | | (70/30) |

### Example 12

### Metal Nanofibers

To produce metal nanofibers, the electrospun precursor nanofibers of Examples 2-11 are heated at a temperature of 600-1000° C. and held there for 10 min to 20 hours under argon or a mixture of argon and hydrogen.

### Example 13

### Metal Oxide Nanofibers

To produce metal oxide nanofibers/nanostructures, the electrospun precursor nanofibers of Examples 2-11 are heated to a temperature of 600-1000° C. and held there for 10 min to 20 hours under air.

### Example 14

### Metal Carbide Nanofiber Nanostructures

To produce metal carbide nanofibers, the electrospun precursor nanofibers of Examples 2-11 are heated to a temperature of 1000-1700° C. and held there for 10 min to 20 hours. For example, treatment of nanofibers produced by electrospinning fluid stocks prepared by combining silicon acetate and PVA, iron acetate and PVA, and titanium dioxide nanoparticles and PVA, are utilized to produce silicon carbide nanofibers, iron carbide nanofibers, and titanium carbide nanofibers.

### Example 15

### Nanocomposite Nanofibers

To produce coaxially layered composite nanofibers/nanostructures, a first fluid feed comprising a first metal precursor and first polymer is coaxially electrospun with a second fluid feed comprising a second metal precursor and a second polymer (which may be the same or different from the first). The electrospun precursor nanofibers are then heated to a temperature of 600-1000° C. and held there for 10 min to 20 hours under air, argon, a mixture of argon and hydrogen, or a sequence thereof (e.g., first air and then a mixture of hydrogen and argon if a zirconia/metal nanocomposite is desired). For example, treatment of nanofibers produced by coaxially electrospinning fluid stocks of (a) zinc acetate/PVA and zirconium acetate/PVA, (b) silver acetate/PVA and zirconium acetate/PVA; (c) nickel acetate/PVA and zirconium acetate/PVA, (d) iron acetate/PVA and zirconium acetate/PVA, (e) nickel acetate/PVA and aluminum acetate/PVA, and (f) iron acetate/PVA and iron acetate/nickel acetate/PVA were utilized to produce coaxially layered nanostructures of zinc oxide/zirconia, silver/zirconia, nickel/zirconia, iron/zirconia, nickel/alumina, and iron oxide/iron-nickel alloy.

### Example 16

### Continuous Carbon Matrix, Discrete Metal Domain Nanofibers

To produce metal carbide nanofibers, the electrospun precursor nanofibers of Examples 2-11 are heated to a temperature of 300-600° C. and held there for 10 min to 20 hours.

### Example 17

### Electrical Conductivity

A two point probe, following ASTM protocols, is used to measure the electric conductivity of various nanofiber mats at various distances along the samples (comprised of 1 total gram of nanofibers). FIG. 9 shows that treated nanofiber mats prepared by the methods of the disclosure exhibit very high conductivity and have improved conductivity compared to nanofiber mats prepared isotropically. Over short distances, it can be seen that the electrical conductivity of the isotropic, curled mats can be similar to that of the flat “checkerboard” structures. However, over longer distances the electrical conductivity of these isotropic structures having shorter, curled nanofibers quickly decays.

### Example 18

### Surface Analysis

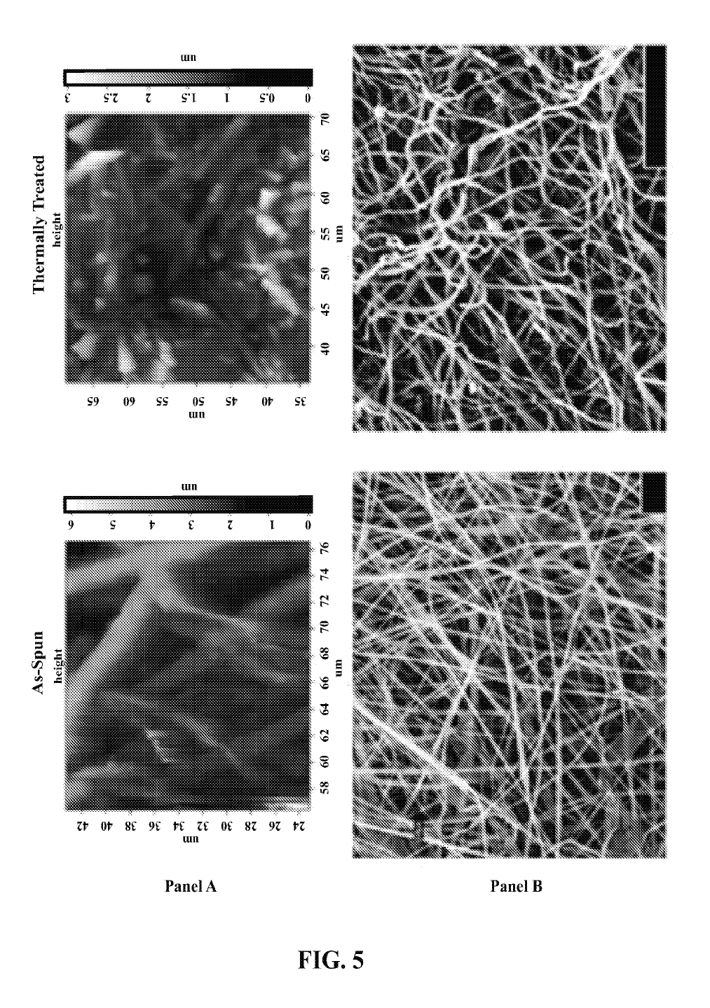

Surface topology for isotropic and “checkerboard” nanofiber mats both before and after thermal treatment was probed via atomic force microscopy (AFM), scanning electron microscopy (SEM), and ellipsometry. These three analyses of surface topology at three different length scales provided individual nanofiber morphology, overall nanofiber morphology, and macroscopic mat structure, respectively. As can be seen in FIG. 5A, the AFM images of the isotropic nanofiber mats display randomly oriented nanofibers that are subsequently broken or curled following the thermal treatment. The SEM images in FIG. 5B further detail a similar significant morphology change. The as-spun case, where a fairly uniform, randomly oriented but linear nanofiber is commonly found, differs greatly from the thermally treated case where nanofibers are significantly curled after thermal treatment. The individual nanofiber morphology fluctuation observed here has a strong impact on the macroscopic mat. This was demonstrated by probing the nanofiber mat surface using ellipsometry after a thin (˜5 nm) sputter coating to increase reflectivity. (Ellipsometry was conducted after adding sputter-coating a 5 nm layer of palladium onto each nanofiber sample and using standard variable angle ellipsometry to calculate the surface normal direction at 100 points evenly distributed in a 10 by 10 grid format on each 5 cm by 5 cm nanofiber mat.) The field plots of the offset angle of normal vector to flat surface for isotropic nanofiber mats (5 cm by 5 cm) before and after thermal treatment are shown in FIG. 5C. The as-spun isotropic mat is initially fairly flat with ˜2 degrees as the maximum offset angle of normal vector to the flat surface. However, upon thermal treatment—as was demonstrated previously by the AFM and SEM images—the individual nanofibers curl and fracture significantly which results in the curling of the macroscopic nanofiber mat as a whole. The maximum offset angle in the isotropic nanofiber mat after thermal treatment reached 30 degrees, an unacceptable level for use in many applications.

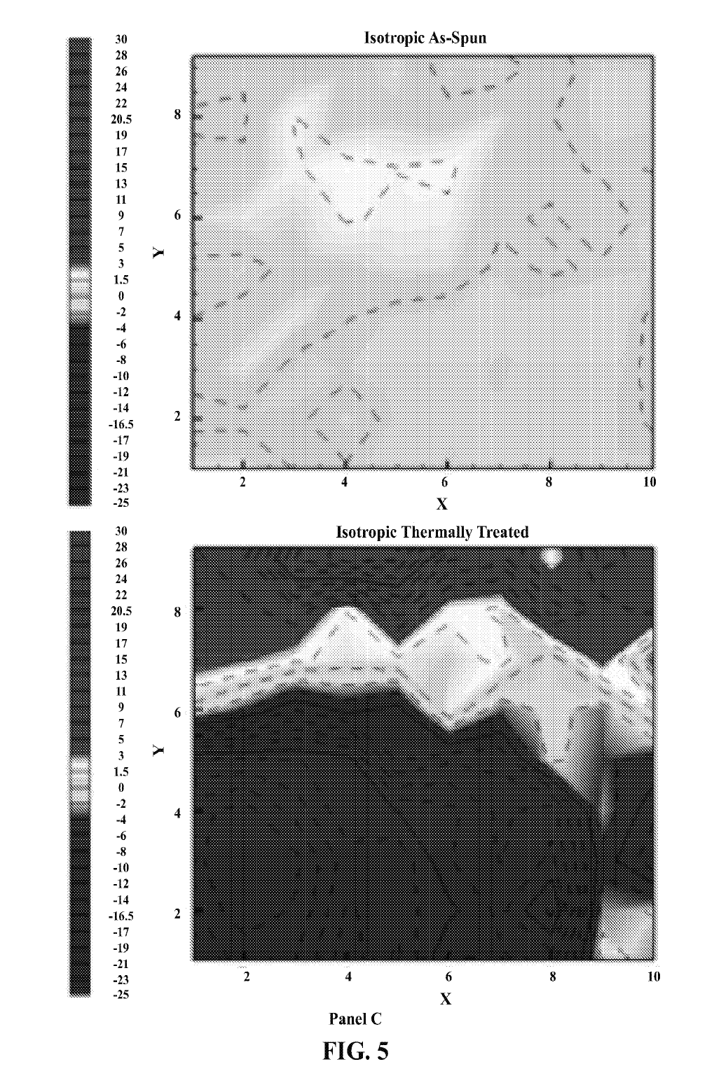

The “checkerboard” approach AFM images shown in FIG. 6A confirm linear, aligned nanofibers with minimal curling or fracture in both the as-spun nanofibers and those thermally treated. The SEM images in FIG. 6B also detail this decrease in morphology fluctuation. It can be seen that the nanofibers, while sparsely populated to allow for viewing of the “checkerboard” structure, are oriented in alternating aligned layers. Additional SEM images of highly populated nanofiber mats are inlaid these SEM images to display strong orientation and linear structure though only a single direction is observed due to the high population. The same ellipsometry measurements for large scale nanofiber mats (5 cm×5 cm) further display the macroscopic effects of the microscopic control of this curling phenomenon. As shown in FIG. 6C, as-spun nanofiber mats generated by the “checkerboard” approach display extremely flat surfaces with a maximum offset angle of −1 degree. Further, the flat nanofiber mat structure retained through thermal treatment and thus the maximum offset angle only increases to −3.2 degrees.

Average retention in radial volume fraction following thermal treatment through AFM and SEM images are presented in FIG. 8. First, the average nanofiber length was determined for samples of isotropic morphology, a single aligned layer, and “checkerboard” samples of three, five and seven total layers for thermally treated nickel oxide, zinc oxide (FIG. 7). This was done by tracing the length of 50 individual nanofibers via SEM. An amorphous alumina nanofiber sample that showed little or no curling through thermal treatment was also shown for comparison. As can be seen the length of the isotropic crystalline nanofibers are an order of magnitude shorter than the non-crystalline alumina material potentially due to the axial breakage observed through AFM in FIG. 5C. The average length of the nanofibers further decreases when a single aligned layer fabricated, but it significantly and quickly increases when only a few layers of alternating aligned layers are used to the point that it approaches the length of the non-crystalline alumina nanofiber sample. In some instances, upon treatment of isotropic (as spun, pre-treatment) nanofiber mats, the nanofiber mat contracts in on itself resulting in the breaking and curling of individual nanofibers observed through AFM and SEM, which subsequently induces the destruction of mat integrity observed in ellipsometry at large scale. In some instances, the “checkerboard” approach provides long nanofiber length and inhibition of axial shrinkage and contraction upon thermal treatment (e.g., by offering perpendicular support through the alternating aligned layers). In some instances, the length of the individual nanofibers is maintained with minimal curling resulting in the maintenance of long range mat structure.

1. A process for preparing a multilayered nanofiber material, the process comprising:
a. electrospinning a first nanofiber layer onto a collector, the first nanofiber layer comprising a plurality of first nanofiber segments, the first nanofiber layer being oriented in a first direction, the first direction being an average direction of the first nanofiber segments; and
b. electrospinning a second nanofiber layer on top of the first nanofiber layer, the second nanofiber layer comprising a plurality of second nanofiber segments, the second nanofiber layer being oriented in a second direction, the second direction being an average direction of the second nanofiber segments;
the first nanofibers and the second nanofibers being the same or different; the first and second directions are oriented at 1-90 degrees to one another; and the deposition of the nanofiber layers producing a nanofiber material with a distinctly layered structure.

2. The process of claim 1, wherein nanofibers of either or both of the first and/or second nanofiber layer(s) comprise (i) polymer; and (ii) metal precursor or nanoparticles; and wherein the nanofiber(s) of the first nanofiber layer are the same or different than the nanofiber(s) of the second nanofiber layer.

3. (canceled)

4. The process of claim 1, wherein the first and/or second nanofibers are electrospun with a gas stream.

5. (canceled)

6. The process of claim 1, wherein the first and second directions are oriented at 30-90 degrees to one another.

7. The process of claim 1, further comprising thermally treating the multilayered nanofiber material, and (i) one or more first nanofiber(s) comprising the plurality of first nanofiber segments and the first nanofiber(s) being converted into third nanofiber(s); (ii) one or more second nanofiber(s) comprising the plurality of second nanofiber segments and the second nanofiber(s) being converted into third nanofiber(s); or (iii) both (i) and (ii).

8. The process of claim 7, wherein following thermal treatment: (i) one or more first nanofiber(s) comprise the plurality of first nanofiber segments and the first nanofiber(s) are converted into third nanofiber(s), the third nanofiber(s) having an average density, average volume and/or average diameter that is less than that of the first nanofiber(s); (ii) one or more second nanofiber(s) comprise the plurality of second nanofiber segments and the second nanofiber(s) are converted into fourth nanofiber(s), the fourth nanofiber(s) having an average density, average volume and/or average diameter that is less than that of the first nanofiber(s); or (iii) both.

9-12. (canceled)

13. The process of claim 1, wherein (i) the plurality of first nanofiber segments of the first nanofiber layer are parallel to one another; (ii) the plurality of second nanofiber segments of the second nanofiber layer are parallel to one another; or (iii) both.

14. The process of claim 1, wherein (i) at least 50% of the plurality of first nanofiber segments of the first nanofiber layer are aligned within 15 degrees of the first nanofiber layer; (ii) at least 50% of the plurality of second nanofiber segments of the second nanofiber layer are aligned within 15 degrees of the second nanofiber layer; or (iii) both.

15. (canceled)

16. The process of claim 1, wherein the first and second directions are oriented at 30-90 degrees to one another.

17. The process of claim 1, wherein the nanofiber segments are aligned by:
a. moving an electrospinner in relation to the collector;
b. moving the collector in relation to an electrospinner;
c. manipulating an electrical field between an electrospinner and the collector;
d. utilizing a gas stream to control the movement and deposition of the electrospun nanofiber;
e. flowing a fluid past the deposited nanofibers;
f. aligning the nanofibers with a magnetic field; or
g. any combination thereof.

18-21. (canceled)

22. The process of claim 7 wherein:
the average diameter of the third and fourth nanofibers are less than the average diameter of the first and second nanofibers, respectively; and
the average length of the third and fourth nanofibers are substantially the same as the length of the first and second nanofibers, respectively.

23. The process of claim 7, wherein the third and fourth nanofibers have an average length of at least 750 μm.

24. The process of claim 1, further comprising electrospinning at least one additional nanofiber layer on top of the first and second nanofiber layers.

25-28. (canceled)

29. The process of claim 1, wherein the polymer is polyvinyl alcohol (PVA), polyvinyl acetate (PVAc), polyacrylonitrile (PAN), polyvinyl ether, polyvinyl pyrrolidone, polyglycolic acid, polyethylene oxide (PEO), hydroxyethylcellulose (HEC), cellulose, ethylcellulose, cellulose ethers, polyacrylic acid, polyisocyanate, or any combination thereof.

30-31. (canceled)

32. The process of claim 3, wherein the metal precursor is a metal acetate, metal nitrate, metal chloride, metal alko-oxide, metal acetylacetonate, or any combination thereof.

33. (canceled)

34. The process of claim 3, wherein the metal is Fe, Ti, Si, Ag, Cu, Ni, Co, Au, Al, Zr, Li, Mg, Ca, Hf, Mn, Ru, Rh, Zn, Cd, Sn, Ge, Pb, Cr, or any combination thereof.

35. A multilayered nanofiber mat comprising at least two nanofiber layers, the nanofiber mat being prepared according to claim 1.

36. A multilayered nanofiber mat, the multilayered nanofiber mat comprising at least two layers, including at least a first nanofiber layer and a second nanofiber layer;
the second nanofiber layer being adjacent the first nanofiber layer;
the first nanofiber layer comprising a plurality of first nanofiber segments, the plurality of first nanofiber segments being aligned with one another, one or more first nanofibers comprising the plurality of first nanofiber segments;
the second nanofiber layer comprising a plurality of second nanofiber segments, the plurality of second nanofiber segments being aligned with one another, one or more second nanofibers comprising the plurality of second nanofiber segments;
the first and second nanofibers being the same or different; and
the orientation of the first nanofiber layer being non-parallel with the orientation of the second nanofiber layer.

37. A multilayered nanofiber mat comprising at least two layers, each layer comprising a plurality of nanofiber segments, at least 50% of the nanofiber segments of each layer being oriented within 15 degrees of the orientation of the nanofiber layer within which the plurality of nanofiber segments reside, and each layer being oriented at an angle of 1-90 degrees of any adjacent layer(s).

38. (canceled)

39. The multilayered nanofiber mat of claim 37.

40-55. (canceled)
